(19) United States
(12) Patent Application Publication
(10) Pub. No.: US 2015/0186386 A1
(43) Pub. Date: Jul. 2, 2015

(54) VIDEO PLAYER WITH ENHANCED CONTENT ORDERING AND METHOD OF ACQUIRING CONTENT

(71) Applicant: Joel Hilliard, Boulder, CO (US)

(72) Inventor: Joel Hilliard, Boulder, CO (US)

(21) Appl. No.: 14/657,945

(22) Filed: Mar. 13, 2015

Related U.S. Application Data
(63) Continuation-in-part of application No. 13/917,466, filed on Jun. 13, 2013.
(60) Provisional application No. 61/952,650, filed on Mar. 13, 2014.
(60) Provisional application No. 61/747,056, filed on Dec. 28, 2012.
(60) Provisional application No. 61/659,273, filed on Jun. 13, 2012.

(51) Int. Cl. G06F 17/30; H04L 29/06; G06F 3/0484

(52) U.S. Cl. CPC G06F 17/30058; G06F 3/0484; H04L 65/604; H04L 65/605

(57) ABSTRACT

A distributed multimedia player allows a user to purchase multimedia regardless of the website or environment upon which the multimedia is encountered. The player may be hosted by self-contained servers or by modules within third-party servers. The player can provide multimedia to a user in a third party server, allow the user to change the content of a playlist, create previews associated with multimedia files, insert multimedia in a third party server, or locate multimedia based on social media connections. The player may also provide video advertisements, with the ability to mute selectively an associated audio track, and may provide the ability to purchase a product associated with the video advertisement. The player provides the user with added speed and convenience over previous players that required the user to obtain information about a multimedia file or product then purchase the product at a separate provider.

### CROSS-REFERENCE TO RELATED APPLICATIONS

This application is a continuation-in-part and claims the benefit of and priority to U.S. patent application Ser. No. 13/917,466, filed Jun. 13, 2013, which claims priority to U.S. Provisional Patent Application Ser. Nos. 61/747,056 and 61/659,273, filed Dec. 28, 2012 and Jun. 13, 2012, respectively. The present application also claims priority, under 35 U.S.C. §119(e), to U.S. Provisional Patent Application Ser. No. 61/952,650, filed Mar. 13, 2014. The entire contents of each of the foregoing Applications are incorporated herein by reference in their entirety for all that they teach and for all purposes.

### BACKGROUND

Millions of individuals listen to digital music and/or view digital video content each day. As many individuals can attest, oftentimes a song may be playing or a video may be viewed which the listener/viewer desires to purchase. For example, a viewer can be viewing a digital video, find it enjoyable or entertaining, and immediately desire to purchase a copy of the video. Typically, to effect such a purchase, the individual will have to obtain information regarding the video, such as, for example, the source of the video (i.e. the name of the compilation on which the video may be featured or found), the retailer or distributor of the video, and/or the price of a copy of the video. The user may then visit a content provider or seller (e.g., iTunes, Amazon, etc.) to purchase the video. Thereafter, the individual can purchase the copy of the respective video.

More often than not, however, an individual's desire to purchase a copy of a respective video content is stronger at the time the individual is viewing the same, and that desire can fade away if not acted upon quickly. In this manner, individuals may not satisfy their desires and producers or distributors of the respective video content can be deprived of sales which could have been made had the individual been able to act on his or her impulse. Unfortunately, the user is often delayed in purchasing the content because they must visit a separate entity or website to affect the purchase.

In today's information age, individuals are accustomed to, and typically expect, if not demand, to be able to make purchases and/or to otherwise act on their desires in an instant, particularly if they are users of mobile technologies, such as portable desktop accessories, mobile cellular devices, electronic tablets, laptop computers, or other devices capable of viewing digital media content. Yet, in spite of this, no system or apparatus is currently available which can provide an individual with the ability to purchase a copy of a respective video, television show, television program, movie, or similar object instantly either during, or in conjunction with, a broadcast of same, or shortly thereafter. Further, no system or apparatus is currently available which can facilitate the purchase of a copy of a respective video, album, television show, television program or movie, or similar object via a respective media playing device, such as portable desktop accessories, mobile cellular devices, electronic tablet or laptop computers or other devices capable of viewing digital media content, on or over which the respective video, album, television show, television program, or movie, is being played. The problem today is there are multiple disparate processes that have to occur in order to successfully conduct a transaction between a merchant service and a store front. Thus, the use's desire for instant gratification in buying the media content as they are enjoying the content is thwarted.

### SUMMARY

There is a need for a distributed multimedia player that allows a user to purchase multimedia regardless of the website or environment upon which the multimedia is encountered. These and other needs are addressed by the various aspects, embodiments, and/or configurations of the present disclosure. Also, while the disclosure is presented in terms of exemplary embodiments, it should be appreciated that individual aspects of the disclosure can be separately claimed.

Embodiments provide for a multimedia player. The various system components and/or modules discussed herein may include one or more of an enhanced multimedia player that may be embedded in one or more third party servers or websites. The enhanced multimedia player can provide an interface to the user that allows the user to purchase the content being viewed or content provided on the third party server or website. The enhanced multimedia player may then communicate with a host server or other computing systems including: (i) a processor for processing digital data; (ii) a memory coupled to the processor for storing digital data; an input digitizer coupled to the processor for inputting digital data; (iii) an application program stored in the memory and accessible by the processor for directing processing of digital data by the processor; (iv) a display device coupled to the processor and memory for displaying information derived from digital data processed by the processor; and (v) a plurality of databases together with their database management systems. The host server may interact to the enhanced multimedia player or react to information sent by the enhanced multimedia player to purchase the multimedia content and provide that content to the user.

It is another aspect of the present invention to provide a computing system. The computer system includes, but is not limited to: (1) a multimedia player module that plays or presents multimedia files for a user when visiting a website associated with a Kakoona server; (2) a user interface module that provides the user interfaces for the multimedia player module or other functions of the Kakoona server; (3) a third party interface module that communicates with a third party server; (4) a user interaction module that receives and interprets user interactions within the user interfaces provided by the user interface module; (5) a database interface module that interfaces with a user database and a multimedia database; and (6) a multimedia creation and management module that receives new multimedia files and manages those multimedia files.

In accordance with another aspect of the present invention, another computing system is disclosed. The computing system generally comprises: (1) an intercept module that intercepts different user interface inputs from a third party server that may be associated with functionality provided by a Kakoona server; (2) an identifier module that identifies multimedia playing with a multimedia player on the third party server; (3) a reroute module that reroutes different inputs from the third party server to the Kakoona server or to a user computer; (4) an overlay user interface module that provides a user interface that exists on top of or over a multimedia presentation; and(5) an embed module that embeds multimedia files into third party servers.

In another aspect of embodiments of the present invention, a computing system for purchasing multimedia content is disclosed and generally comprises: (1) a Kakoona server in communication with a user database and a multimedia database; (2) one or more third party servers, each having an Internet interface, a Kakoona module, and a multimedia database; and (3) one or more user computers, each in communication with a separate user local database, wherein the Kakoona server is in communication with each of the one or more third party servers and each of the one or more user computers, and each of the one or more third party servers is in communication with each of the one or more user computers.

Still another aspect of embodiments of the present invention is a computer-readable medium embodying a database or data structure for storing user information, comprising, with respect to each of one or more users: (1) user credential data, being any type of user name, password, or other information used to identify the user; (2) user biographic data, being any information or metadata about the user's preferences and history; and (3) a multimedia pointer for each of one or more multimedia files associated with the user. Optionally, in one embodiment, the user credential data comprises one or more of alphanumeric data and biometric data. In another embodiment, the user biographic data can be accessed by one or more other users to provide for a social interaction. In still another embodiment, the multimedia pointer provides for access to multimedia within a multimedia database. In yet another embodiment, the database interface module of a Kakoona server can add a new multimedia pointer to the database when the user buys a new multimedia file to demonstrate that the user owns the multimedia file.

The term “multimedia” or “multimedia content” as used herein refers to any digital content a user may view through the use of the multimedia playing device, by way of example but not limitation, website and social media digital content accessible through a networked connection, video files, audio files, etc.

The term “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module” as used herein refers to any known or later developed hardware, software, firmware, artificial intelligence, fuzzy logic, or combination of hardware and software that is capable of performing the functionality associated with that element.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram of an embodiment of the hardware and/or software modules that form a system for purchasing multimedia content;

FIG. 2 is a block diagram of an embodiment of the hardware and/or software of modules for a Kakoona module;

FIG. 3 is a block diagram of an embodiment of the hardware and/or software of modules for a Kakoona server;

FIG. 4 is a block diagram of an embodiment of a database and/or data structure for storing user information;

FIG. 5 is a block diagram of an embodiment of a database and/or data structure for storing multimedia content information;

FIG. 6 is a block diagram of an embodiment of a database and/or data structure for storing playlist information;

FIG. 7 is a visual representation of an embodiment of a user interface for an enhanced multimedia player;

FIG. 8 is another visual representation of an embodiment of a user interface for an enhanced multimedia player;

FIG. 9 is another visual representation of an embodiment of a user interface for an enhanced multimedia player;

FIG. 10 is another visual representation of an embodiment of a user interface for an enhanced multimedia player;

FIG. 11 is another visual representation of an embodiment of a user interface for an enhanced multimedia player;

FIG. 12 is another visual representation of an embodiment of a user interface for an enhanced multimedia player;

FIG. 13 is another visual representation of an embodiment of a user interface for an enhanced multimedia player;

FIG. 14 is another visual representation of an embodiment of a user interface for an enhanced multimedia player;

FIG. 15 is another visual representation of an embodiment of a user interface for an enhanced multimedia player;

FIG. 16 is another visual representation of an embodiment of a user interface for an enhanced multimedia player;

FIG. 17 is another visual representation of an embodiment of a user interface for an enhanced multimedia player;

FIG. 18 is flow diagram or process diagram of an embodiment of a method for accepting input from a user provided in a user interface of an enhanced multimedia player;

FIG. 19 is flow diagram or process diagram of an embodiment of a method for adding multimedia content to a playlist;

FIG. 20 is flow diagram or process diagram of an embodiment of a method for creating a preview for a multimedia file;

FIG. 21 is flow diagram or process diagram of an embodiment of a method for embedding multimedia content in a third party website or server;

FIG. 22 is flow diagram or process diagram of an embodiment of a method for providing information about and access to multimedia content of third party users associated with a user through social media interactions;

FIG. 23 is a block diagram of an embodiment of the hardware and/or software of a computing environment associated with the embodiments presented herein;

FIG. 24 is a block diagram of an embodiment of the hardware and/or software modules of a computing system associated with the embodiments presented herein;

FIG. 25 is a block diagram of an embodiment of the data communications undertaken by a transaction engine; and

FIG. 26 is a visual representation of an embodiment of an overlay user interface seen in conjunction with the use of an advertising device.

In the appended Figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Presented herein are embodiments of a device. The device can be a communications device, such as a cellular telephone, or other smart device. The device can include two screens that are oriented to provide several unique display configurations. Further, the device can receive user input in unique ways. The overall design and functionality of the device provides for an enhanced user experience making the device more useful and more efficient.

Hardware Features:

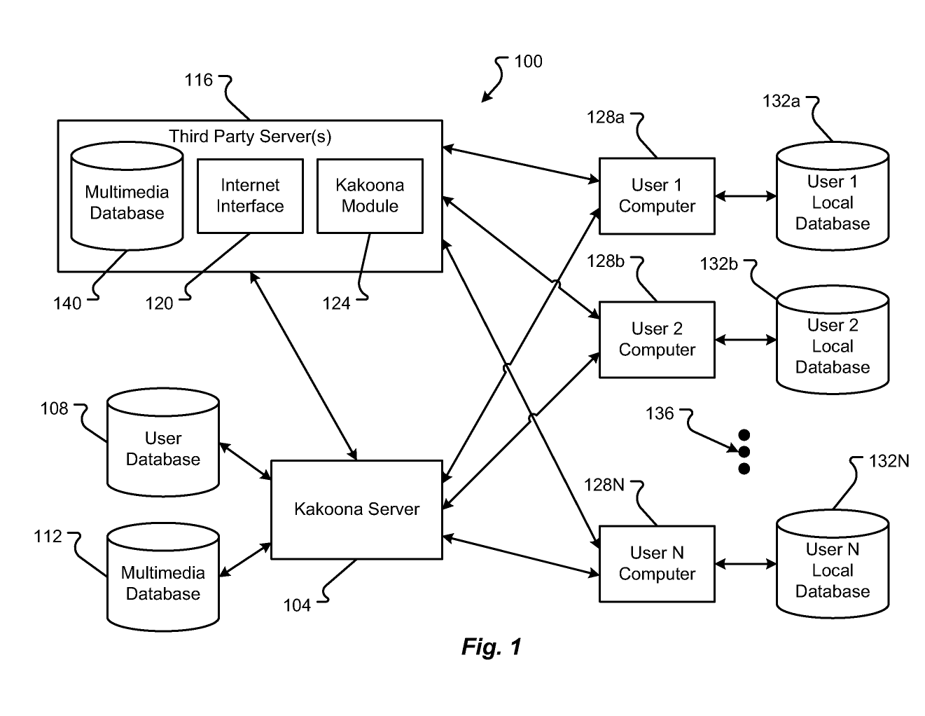

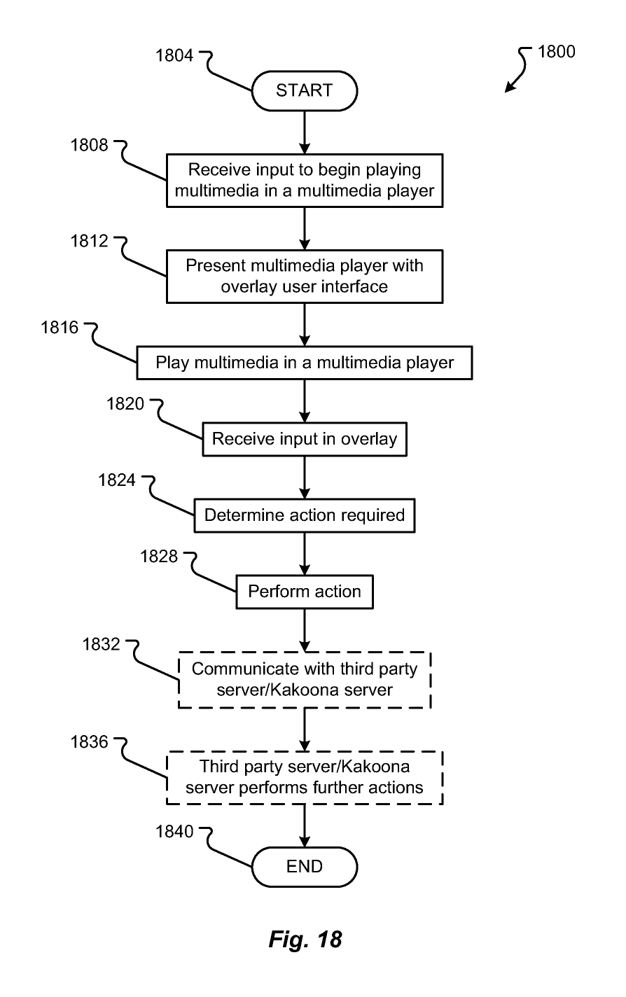

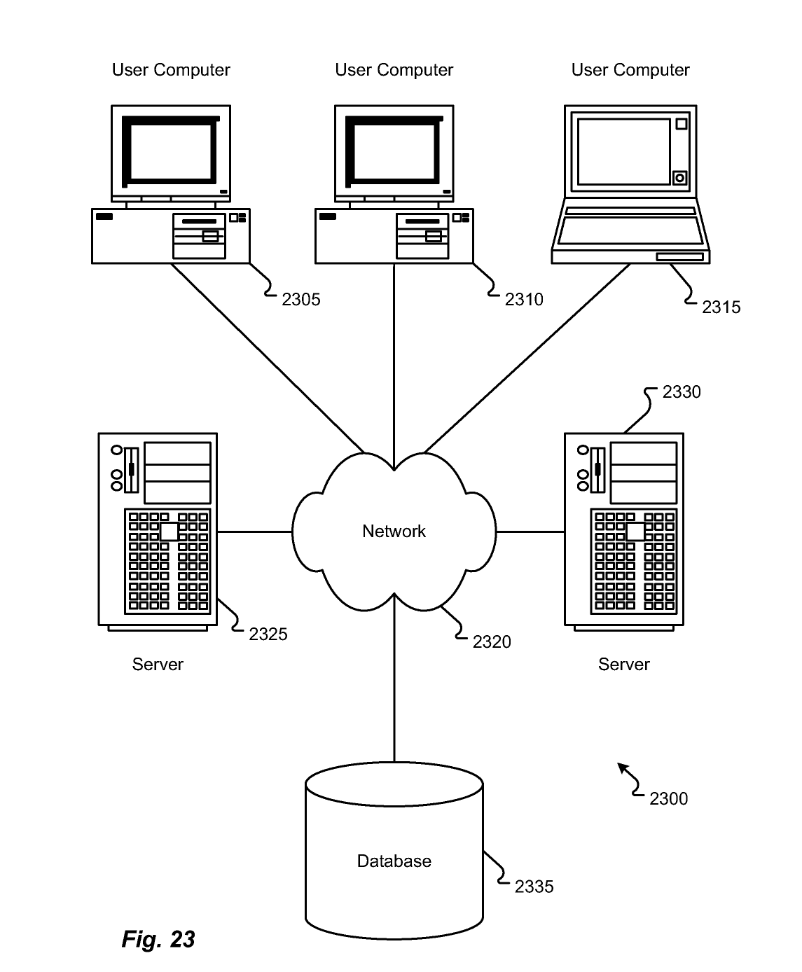

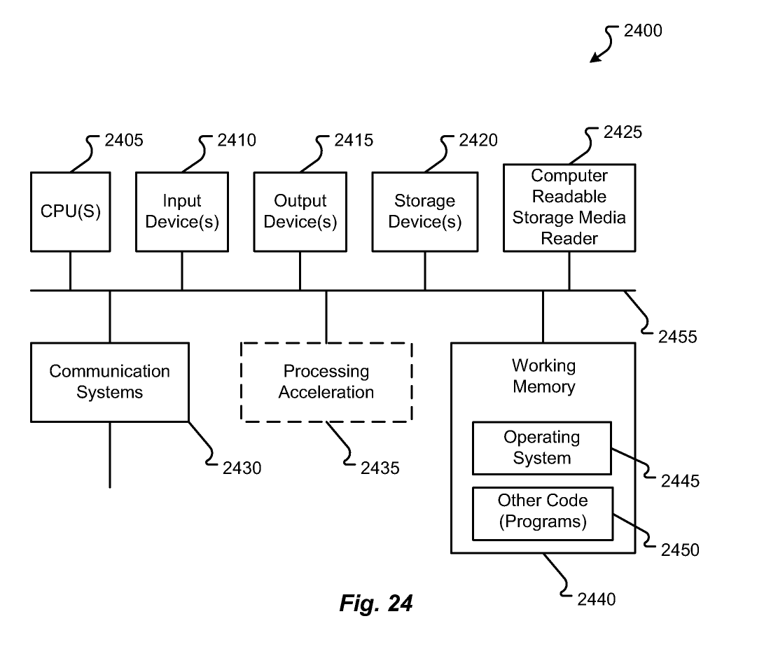

An embodiment of a system 100 for conducting operations described herein, which associated with multimedia content, is shown in FIG. 1. One or more servers or computers 104, 116, and/or 128 may be in communication with each other as described herein. The servers, computers, and/or databases 104, 116, 128, 140, 108, 112, and/or 132 may be similar to the computer systems or databases described in conjunction with FIGS. 23 and 24. The Kakoona server 104 may conduct operations, such as those described in conjunction with FIGS. 18 through 22.

The Kakoona server 104 may be in communication with a user database 108 and a multimedia database 112. The user database 108 may store, manage, or retrieve information associated with one or more users. The multimedia database 112 may store, manage, or retrieve information associated with multimedia. The Kakoona server 104 may use the information within the user database 108 and the multimedia database 112 to conduct different operations described herein.

The Kakoona server 104 may also communicate with one or more third party server(s) 116. Third party server(s) 116 may be another computing system that has an associated website or other interface for conducting operations separate from the Kakoona server 104. Some examples of third party server(s) 116 may include social media sites, such as Facebook, Twitter, or other types of social media. In embodiments, the third party server 116 includes an internet interface 120, which may provide a webpage or other interface for one or more users. The third party server(s) 116 can also include a multimedia database 140 that stores multimedia that is associated with displays on the third party server 116 or associated with the internet interface 120. The multimedia database 140 may store the same or different information from the multimedia database 112.

The third party server(s) 116 may also include a Kakoona module 124. The Kakoona module 124 may conduct different operations described herein including communications with the Kakoona server 104 or the user computer(s) 128a-128N. The Kakoona module 124 may also provide functionality to the third party server(s) 116 that is associated with the Kakoona server 104 or multimedia provided by the Kakoona server 104.

The Kakoona server 104 and the third party server(s) 116 may communicate with one or more user computer(s) 128a-128N. The user computer 128 can be any type of computing device associated with the user, including, but not limited to, desktop computers, mobile devices, laptop computers, eReaders, etc. The user computer 128 may provide the capability to view multimedia for a user. The multimedia may be stored locally, in a user local database 132a-132N, or be provided from multimedia database 112 or 140 by either the Kakoona server 104 or by a third party server 116. There may be more or fewer user computers 128 and/or local databases 132 than those shown in FIG. 1, as represented by ellipses 136.

Firmware and Software:

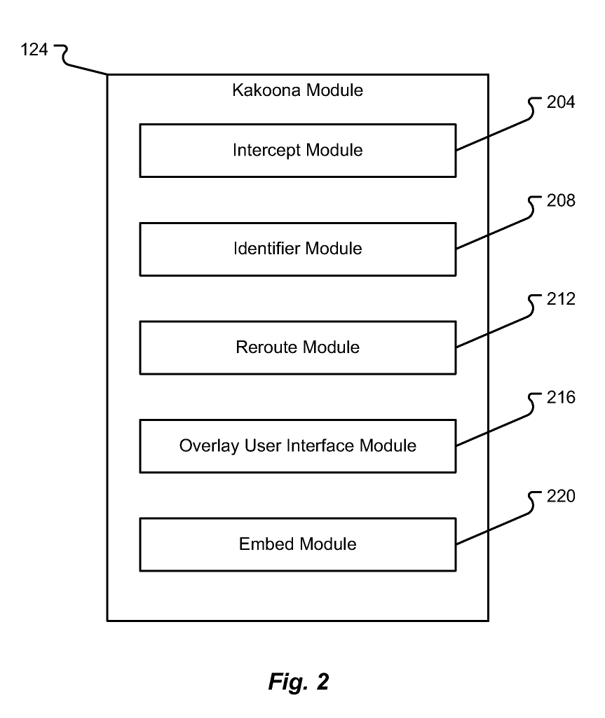

An example of a Kakoona module 124, as described in FIG. 1, is shown with separate submodules in FIG. 2. The Kakoona module 124 may include one or more modules or submodules that provide different functionality to the user computer 128 or a third party server 116. The Kakoona module 124 may include an intercept module 204, an identifier module 208, a reroute module 212, an overlay user interface module 216, an embed module 220, or one or more other modules.

An intercept module 204 may be able to intercept different user interface inputs from the third party server 116 that may be associated with functionality provided by the Kakoona server 104. For example, inputs into a user interface of a multimedia player may be intercepted by the intercept module 204 and then provided to the Kakoona server 104 for providing different operations. Thus, user interface interactions with a media player in a third party server 116 can introduce functionality provided by a Kakoona server 104.

An identifier module 208 may be operable to identify multimedia playing within a multimedia player on a third party server 116. This identifier module 208 may be able to access multimedia database 140 or other metadata associated with the multimedia file that is being presented on the third party server 116. This metadata or information may be provided to the reroute module 212 or to other modules and then communicated to the Kakoona server 104 or a user computer 128. Identifier module 208 may also be able to identify the files for a shopping cart function in the Kakoona module 124. The identifications of the multimedia files may be associated with a single multimedia file or associated with a set or group of multimedia files associated with an album or some other collection that the user may select.

A reroute module 212 may be capable of rerouting different inputs from the third party server 116 to the Kakoona server 104 or to a user computer 128. The reroute module 212, for example, may reroute shopping cart request from the third party server 116 to the Kakoona server 104 for purchase. In other embodiments, the reroute module 212 may be capable of rerouting information from one third party server 116 to a second third party server 116 to embed content onto the second third party server 116. The reroute module necessarily then redirects communications from the Kakoona module 124 to different computer systems to provide for functions as described herein.

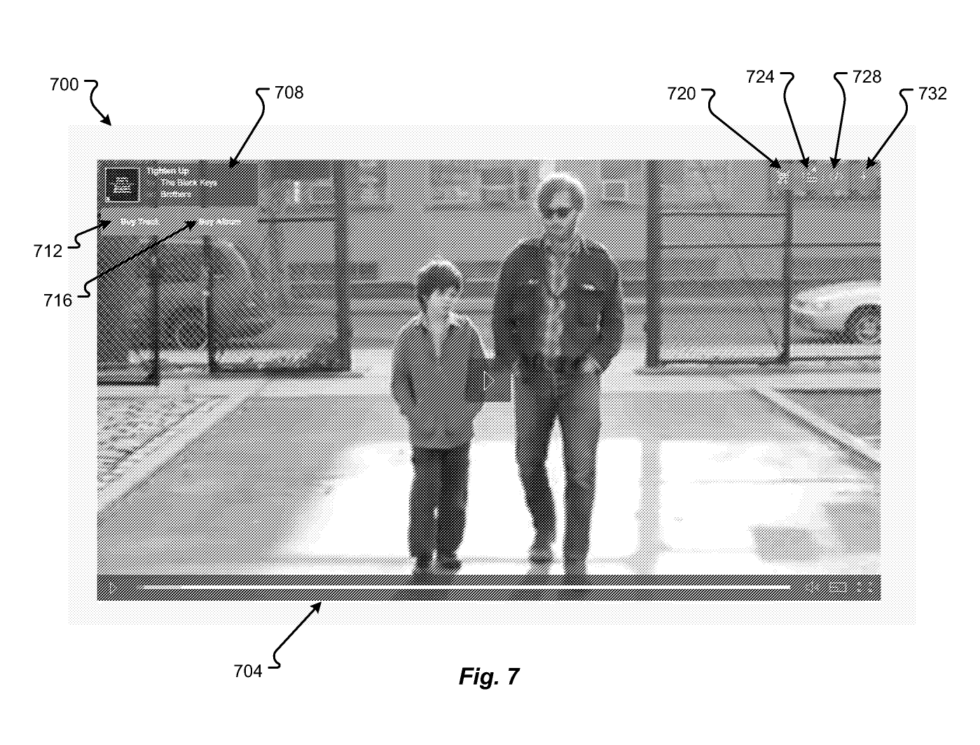

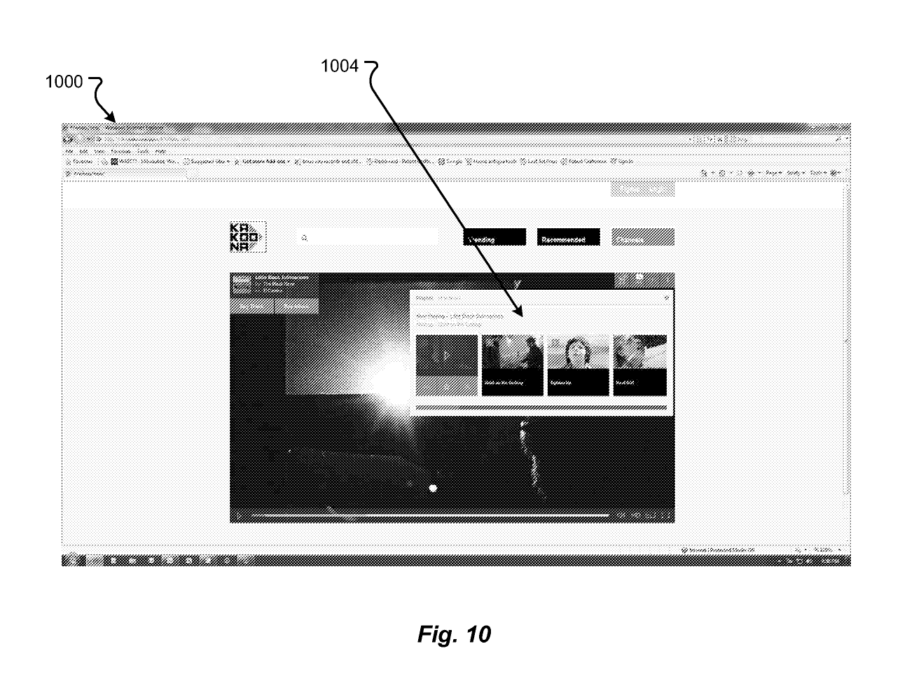

An overlay user interface module 216 may provide a user interface that exists on top of or over a multimedia presentation. The overlay may be as shown in FIGS. 7-16. The overlay interface may have one or more different user interfaces as shown herein. The overlay user interface module 216 may provide information to the intercept module 204 such that the intercept module 204 can determine inputs into the user interface are to be sent to the reroute module 212. Thus, the overlay user interface module 216 may change the different user interfaces that overlay the multimedia players but allow the intercept module 204 to interact with or react to user inputs.

An embed module 220 may be operable to embed multimedia files into third party servers 116. For example, a user may decide to export a multimedia file onto a social media site. To complete the exportation of this multimedia onto the third party site 116, the embed module 220 may accept the embedded information and place or encode the embedded information into the third party server or website 116. In other embodiments, the embed module 220 may be capable of sending or providing a file for embedding in a second or unrelated third party server 116. Thus, the embed module 220 operates to provide for a quick and easy service for the user to embed multimedia presentations into social media or other third party servers 116.

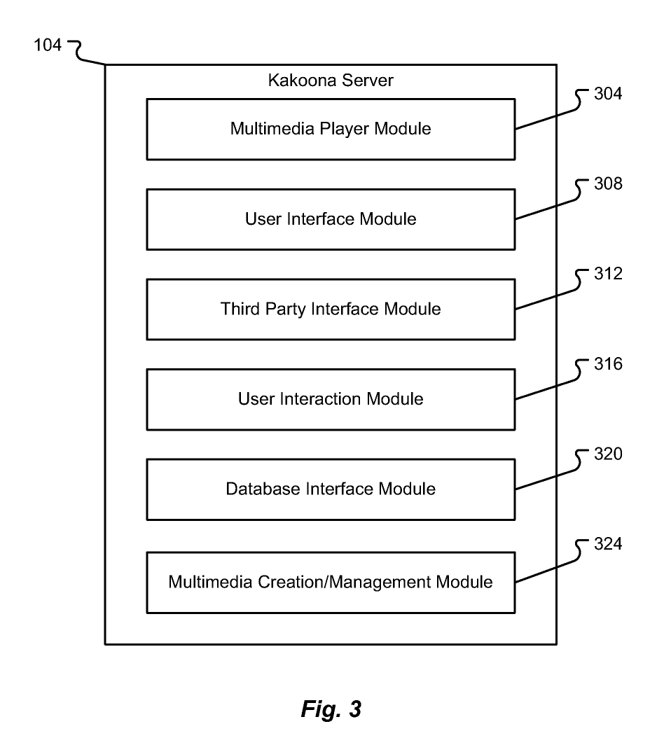

An embodiment of the Kakoona server 104 is shown in FIG. 3. The Kakoona server 104 can include one or more different modules or submodules that provide for the functionality described herein. For example, the Kakoona server 104 may include a multimedia player module 304, a user interface module 308, a third party interface module 312, a user interaction module 316, a database interface module 320, and/or a multimedia creation/management module 324.

The multimedia player module 304 is a module that may play or present multimedia files for a user when visiting a website associated with the Kakoona server 104. The multimedia player module 304 may provide overlays and other user interfaces as previously described. In embodiments, the multimedia player module 304 is operable to play any multimedia provided in the multimedia database 112.

A user interface module 308 may provide the user interfaces for the multimedia player 304 or other functions of the Kakoona server 104. In embodiments, the user interface module 308 can provide the overlays as described herein. The user interface module 308 may also create the website associated with or other interfaces to the Kakoona server 104.

A third party interface module 312 may be operable to communicate with third party server 116. The third party interface module 312 may be able to embed multimedia files into third party server(s) 116, may be able to communicate, translate, or interpret messages to or from third party server(s) 116, or provide for other communications to and from third party server(s) 116. Thus, any communication from the Kakoona module 124 to the Kakoona server 104 may be processed through the third party interface module 312.

A user interaction module 316 may be operable to receive and interpret user interactions within the user interfaces provided by the user interface module 308. For example, if the user makes an input to buy a track or album from a multimedia file, the user interaction module 316 can interpret this input and provide for further functionality based on the input. The user interaction module 316 may be able to respond to any kind of user interaction within a user interface or sent to the Kakoona server 104 from the user computer 128 or the third party server 116.

Database interface module 320 may be operable to interface with the user database 108 and the multimedia database 112. Thus, the database interface module 320 is operable to manage, organize, store, or retrieve information from the databases 108 and 112. The database interface module 320 may operate with any protocol or with any type of database described herein.

A multimedia creation management tool 324 may be operable to receive new multimedia files and manage those multimedia files. For example, a user may create a video or audio file that may be provided to the Kakoona server 104 and stored within the multimedia database 112. The multimedia creation management module 324 can assign the metadata and other information required to store and to manage this multimedia file. Further, the multimedia creation management module 324 may be operable to change or modify the multimedia file or the metadata associated therewith. For example, the multimedia creation management module 324 may be able to change the preview file associated with the multimedia file associated in the multimedia database 112. Various features of the modules and other software components described above are captured in Appendix A of U.S. Provisional Patent Application 61/952,650, which is incorporated herein by reference in its entirety.

Database Features:

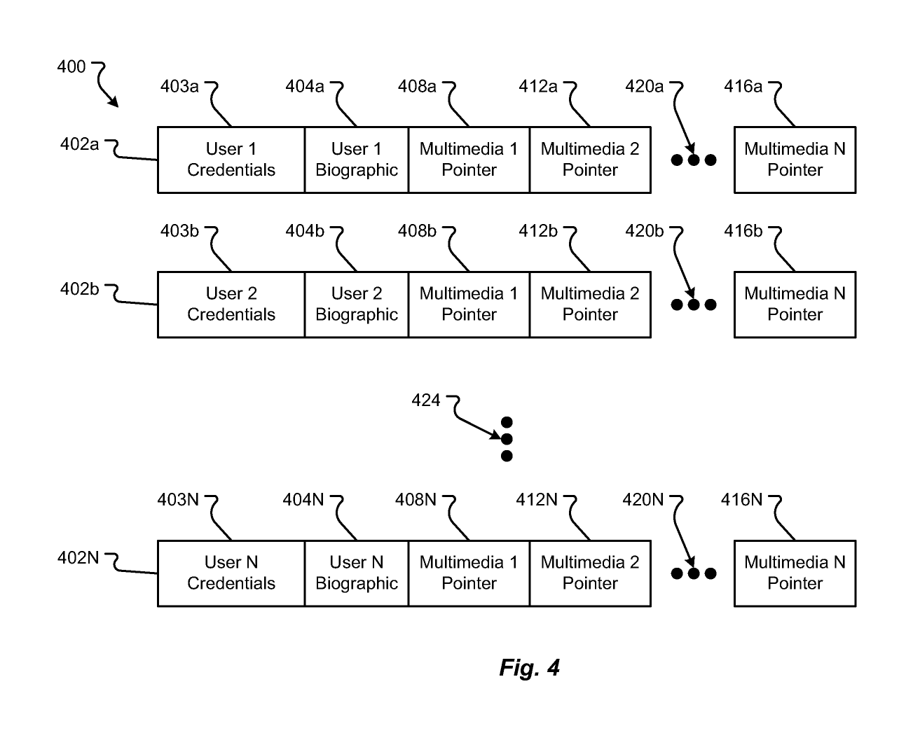

An embodiment of data stored within one or more databases 108, 112, and/or 140 and associated with users is shown in FIG. 4. The database 400 may include one or more files associated with one or more users 402. There may be more or fewer user-associated files 402 within the database 400, as represented by ellipses 424. A user-associated file 402 may include one or more portions that store different data. For example, user-associated file 402 may provide for user credentials 403, user biographics 404, and multimedia pointers 408, 412, and 416, etc. There may be more or fewer portions within each user-associated file 402, as represented by ellipses 420.

User credentials 403 can be any type of user name, password, or other information used to identify the user. These user credentials 403 can be information, such as biometric data or alphanumeric data that is used to identify the user for the third party server 116, the Kakoona server 104, and the user computer 128. The user credential data 403 may be received from a user, may be stored by one or more of the different computing systems, and communicated amongst those computing systems including the Kakoona server 104, the user computer 128, or a third party server 116.

User biographics 404 can include any information or metadata about the user. This biographic information 404 can include information, such as, user preferences, user histories, or how a user has purchased or used the Kakoona service. This information may be accessed by one or more other users to provide for a social interaction.

The user file 402 can include one or more multimedia pointers 408, 412, and/or 416. These multimedia pointers 408, 412, and/or 4l6can provide for access to multimedia within the multimedia database 112. Rather than storing a series of multimedia files with each user file 402, the user file 402 can store pointers to the multimedia that are associated with the user. Thus, if the user buys or purchases a new multimedia file, the database interface module 320 can add a new multimedia pointer 408, 412, and/or 416 to the user file 402 to demonstrate that the user now owns or has purchased this multimedia file.

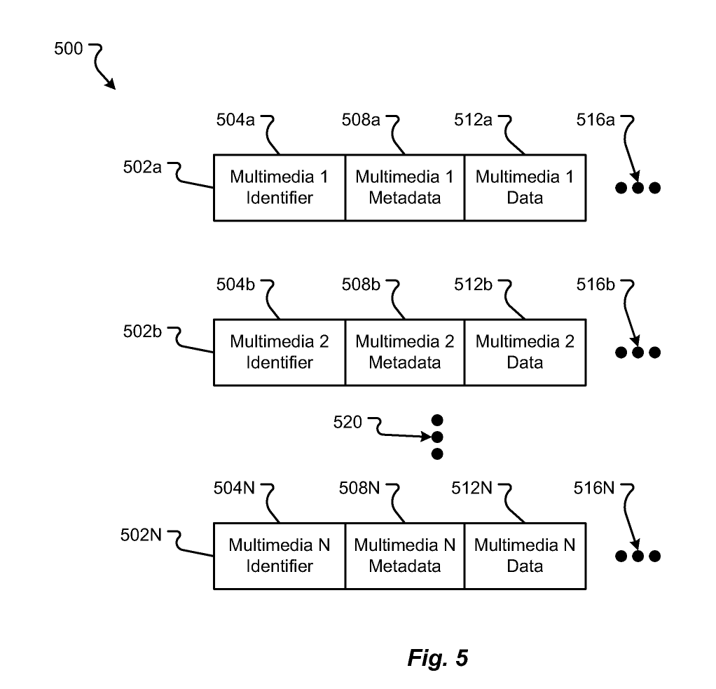

An embodiment of a multimedia database 500 that may be similar or the same as multimedia database 112 or multimedia database 140 is shown in FIG. 5. The multimedia files 502 can include information about multimedia that is provided to a user. The multimedia file 502 may have one or more portions. For example, the multimedia file 502 can include a multimedia identifier 504, a multimedia metadata 508, and multimedia data 512. Each multimedia file 502 may include more or less information than that shown in FIG. 5, as represented by ellipses 516.

The multimedia identifier 504 can be any type of globally unique identifier (GUID) or other type of identifier that is unique to the multimedia file 502 and identifies the multimedia file 502 from the other multimedia files stored in the multimedia database 112, 140. The multimedia metadata 508 is information about the multimedia file. This multimedia metadata 508 can include such things as the artist associated with the multimedia file, the time the track was added to a multimedia database 112, the length of the multimedia file 502, information about a preview associated with the multimedia file 502, or other information as understood in the art.

The multimedia data 512 can include the actual source data used to display or present the multimedia file to a user. This multimedia data 512 may be audio, video, books, video games, images or other types of multimedia data. This multimedia data 512 can be read by the multimedia player module 304 or a multimedia player associated with the third party server 116. The multimedia data 512 may then be used to present this multimedia file 502 to the user.

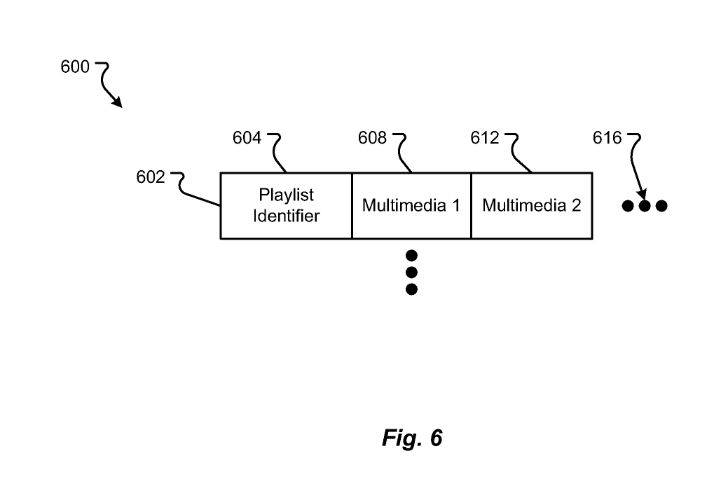

An embodiment of a playlist database 600 is shown in FIG. 6. The playlist database 600 may provide for one or more either permanent or temporary playlists for a user. This information may be created by a user to play multimedia files in a certain arrangement and provide for playing multimedia files consecutively. The playlist data may include a playlist file 602 that includes a playlist identifier 604. The playlist identifier 604 can be any type of GUID or other identifier that uniquely identifies this playlist 602 for the user. The playlist 602 may also include a pointer or other information about the multimedia 608, 612 within the playlist. The pointer 608, 612 provides information to identify, retrieve, and arrange the multimedia data in the playlist 602. There may be more or fewer portions of each multimedia playlist file 602, as represented by ellipses 616. The multimedia data 608 and 612 can include the position of the multimedia within the playlist, the other information such as a pointer to access that multimedia. This multimedia information in multimedia portion 608 and 612 may be changed by adding or changing the playlist.

User Interface Configurations and Interactions:

Referring now to FIG. 18, a method 1800 for providing a multimedia player in a third party server 116 is shown. While a general order for the steps of the method 1800 is shown in FIG. 18. Generally, the method 1800 starts with a start operation 1804 and ends with an end operation 1840. The method 1800 can include more or fewer steps or can arrange the order of the steps differently than those shown in FIG. 18. The method 1800 can be executed as a set of computer-executable instructions executed by a computer system and encoded or stored on a computer readable medium. Hereinafter, the method 1800 shall be explained with reference to the systems, components, modules, software, data structures, user interfaces, etc. described in conjunction with FIGS. 1 through 17, but especially, FIG. 7 through 17 which contain user interfaces for the multimedia player and other embodiments described of herein.

The third party server 116, the Kakoona server 104, or the user computer 128 may receive input to begin playing a multimedia file 502 in a multimedia player, in step 1808. In embodiments, a third party server internet interface 120 may receive an input from a user computer 128 to play a multimedia selection from the multimedia database 140. In contrast, the user may also select a multimedia file 502 to play from a multimedia database 112 using the multimedia player module 304 of the Kakoona server 104. It is also possible that the user computer 128 may play a local multimedia file from a user local database 132. The selection may be received by an intercept module 204 or a user interface module 308. The information may then be processed such that the local multimedia player may play the multimedia file 502 with an overlay user interface, in step 1812.

The third party server 116 may execute a multimedia player and use the Kakoona module 124 to play the multimedia file 502 from multimedia database 140 with an overlay user interface. Likewise, the Kakoona server 104 may execute a multimedia player module 304 and present an overlay user interface with the user interface module 308. An overlay user interface module 216 and the third party server 116 can generate the overlay and provide that overlay above an existing multimedia player or a multimedia player designed to work with the Kakoona module 124. The overlay may be as shown in FIG. 7.

The multimedia player 700 can include a series of different user interaction devices within or included with the overlay user interface. For example, a play bar that includes the length of the track or multimedia file 402 and the current position in the multimedia file 402 or presentation is shown in portion 704. Portion 704 can also include a volume adjust button and an expand/contract device, such that, the multimedia player can be played in a window (a smaller portion of the whole screen) or in a full screen view. The overlay can also include a title or information about the multimedia as shown in portion 708. Further, the overlay may include user selectable portions 712 and 716 that may allow the user to buy the multimedia file or buy an album or a collection that the multimedia file is associated therewith. If the user selectable items 712 and 716 are selected, a file may be added to a shopping cart that may be accessed by user selectable button 720. A playlist or multimedia play list can be shown or accessed through user selectable button 724. Information about the embedded content of the multimedia file may be accessed through user selectable button 728. Further, user selectable button 732 may be used to embed the multimedia file in one or more third party sites. This overlay may be presented in the third party server 116, the user computer 128, and/or the Kakoona server 104. Thus, regardless of where the user may be viewing the multimedia, the Kakoona system may provide this overlay interface functionality to allow the user to both purchase and manage the multimedia file.

The multimedia player 304 or other multimedia player (not shown) herein may play the multimedia, in step 1816. Sometime thereinafter, a user interface may receive input in the overlay, in step 1820. For example, the intercept module 204 may receive an input in one of the sections of the overlay, as described herein. Likewise, the user interaction module 316 may receive an input in the overlay at the Kakoona server 104. Further, the user computer 128 may receive an input into an overlay. The input can be a selection of one of the user selectable buttons or devices 712 through 732.

Based on the input and where or into what user selectable device the input is received, the Kakoona module 124, Kakoona server 104, or user computer 128 may determine the action required to be performed based on the input, in step 1824. If portions or user selectable devices 712 and/or 716 are selected, the input may be received by the interaction module 204, which then provides the information to the identifier module 208 to determine what action needs to be completed or what device was selected. The identifier module 208 may understand that the user desires to buy a track or multimedia file or a collection of multimedia files. The identifier module 208 may collect information about the desired purchase and then provide this information to a reroute module 212 that can send this information to the Kakoona server 104. The Kakoona server 104 may use the third party interface module 312 to receive this information from the reroute module 212. The purchase information may then go into a shopping cart for the user. Thus, the purchase information may be stored in the user database 108 with information provided back to the reroute module 212 to update the overlay user interface to show that there are items in the shopping cart, in button 720. The shopping cart information may be provided to the overlay user interface module 216 to update the overlay user interface.

Likewise, the Kakoona server or the user computer may receive such information through the user interaction module 316. This information may then be sent to the database interface module 320 to update the user database 108 that there is a file(s) in the shopping cart. The user interface module 316 may then update the overlay 720 to show that there are items in the shopping cart. Thus, the identifier module 208 can determine the action required, in step 1828 and provide that information to one or more other modules, such as the reroute module 212, to perform the action, in step 1828. Likewise the user interface module 308 can identify and provide information to the user interaction module 316 to determine the type of action to be performed. The user interaction module 308 or database interface module 320 may then perform the action, in step 1828.

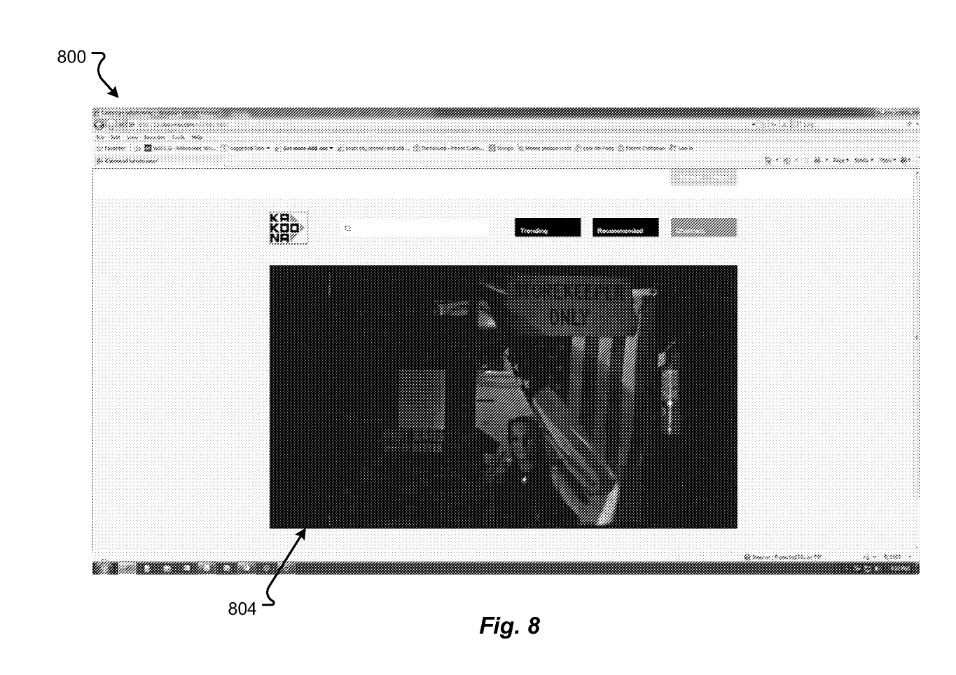

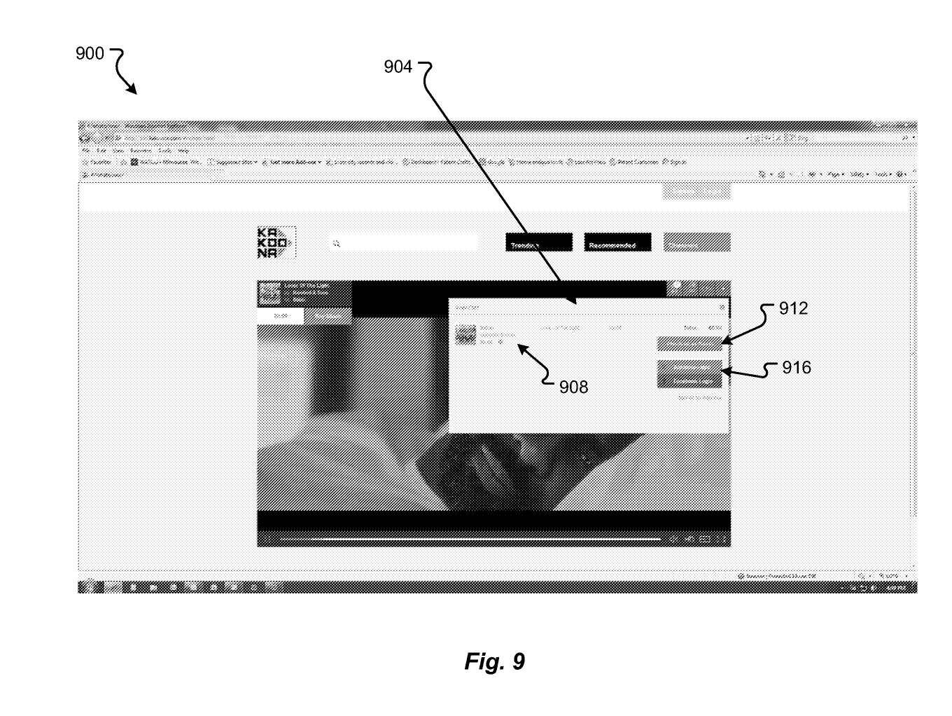

As explained previously, information may be exchanged between the third party server 116 and the Kakoona server 104 to perform the actions as described herein, in optional step 1832. The third party server 116 or Kakoona server 104 may perform further actions, in optional step 1836, as prescribed by the type of action desired. Further examples of how the user interaction or user overlay interface may be used are shown in FIGS. 9 through 12. An example of a multimedia player, which may be used in the Kakoona server 104 or the user computer 128, is shown in FIG. 8. Here the multimedia player 804 may be presented as a webpage or other user interface. The window 800 may be accessed through a website associated with the Kakoona server 104 or through a user computer 128.

In FIG. 9, the user may have selected or be presented with window 900 after selecting the shopping cart user selectable device 720. Here, a new popup window 904 is presented. A display of a selected album and album information 908 is presented showing that the user has selected the song for purchase. The user may then also be presented with a series of user selectable buttons 912 and 916 to check out or purchase the multimedia file through the Kakoona server 104. The user may check out as a guest by selecting device 912 or may log in through a Kakoona or Facebook account using icon 916. Selecting the icons 912 and 916 may reroute the user to the Kakoona server 104 to complete purchase of the multimedia and to have the multimedia stored in the multimedia database 112. When a user is logged in with credit card data stored on the Kakoona server 104, a one-click processing and download solution may be implemented, as further described hereinafter.

A window 1000 may be presented if the user selects user selectable device 724. Here a popup window 104 shows a playlist with four different multimedia files arranged in the order the files will be presented. The playlist may be played on the multimedia player in the order shown in the window 1004.

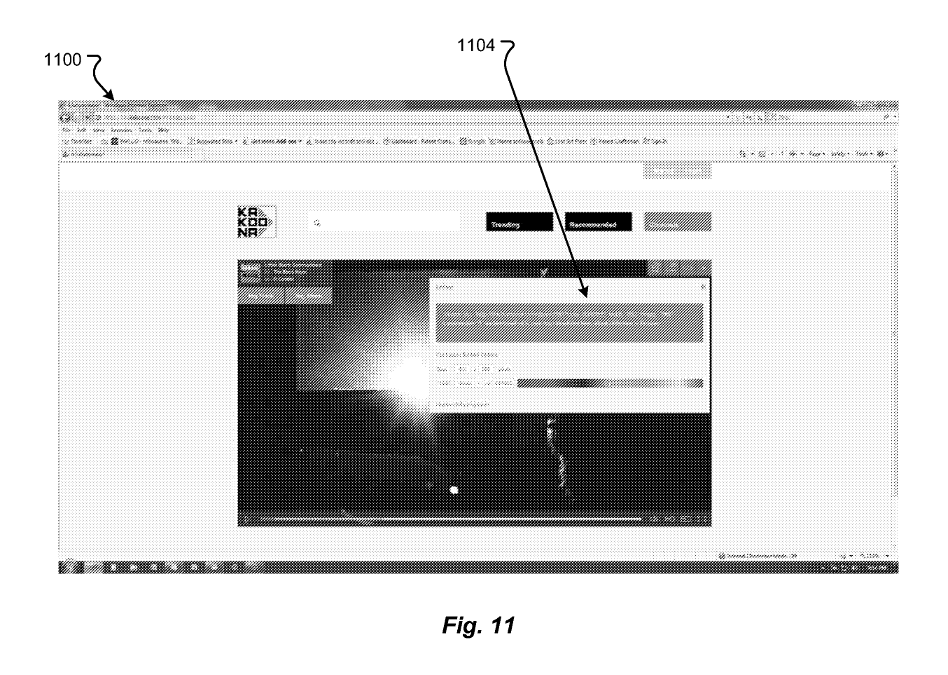

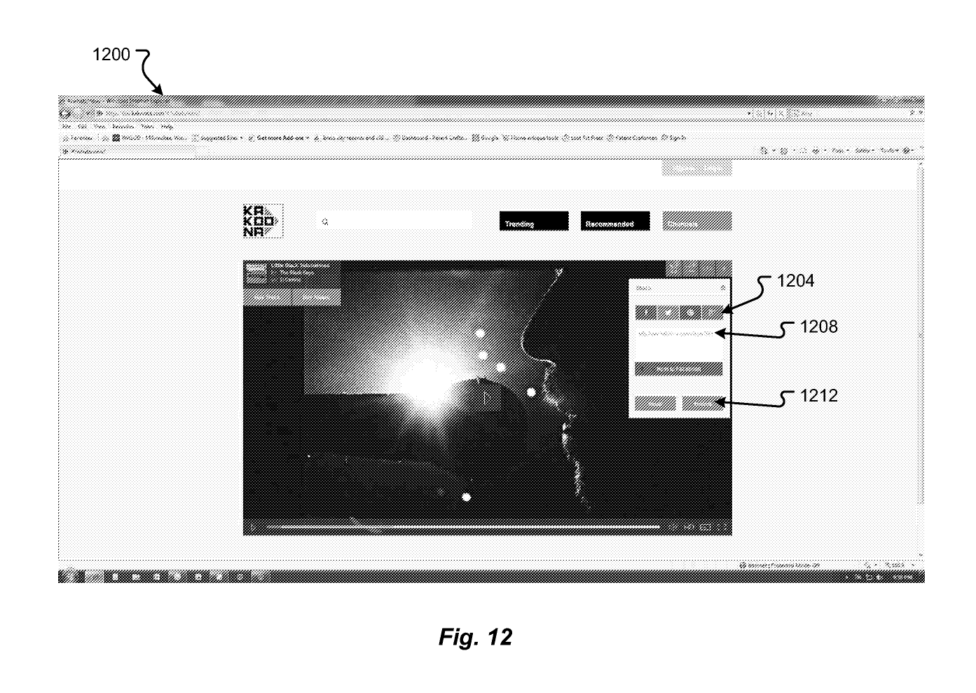

Window 1100, shown in FIG. 11, may be presented if the user selects user selectable device 728. Here, a popup window 1104 provides for the embedded content or information about the multimedia file and how that file may be embedded in a different third party server 116. If the user selects to try to embed the content, they may select user selectable device 732. In response to selecting user selectable device 732, window 1200 may be presented, as shown in FIG. 12. Here, the user is shown a popup window 1200 having one or more selectable devices 1204. These devices allow the user to select a social media or third party server 116 to embed the multimedia file. Information about the multimedia file is shown in display 1208. The user may then select devices 1212 to either email or embed the content. In selecting the embed device 1212, the user may post the embedded comment to the third party server 116. As such, the overlay interface allows the user to quickly and easily embed into another third party server 116.

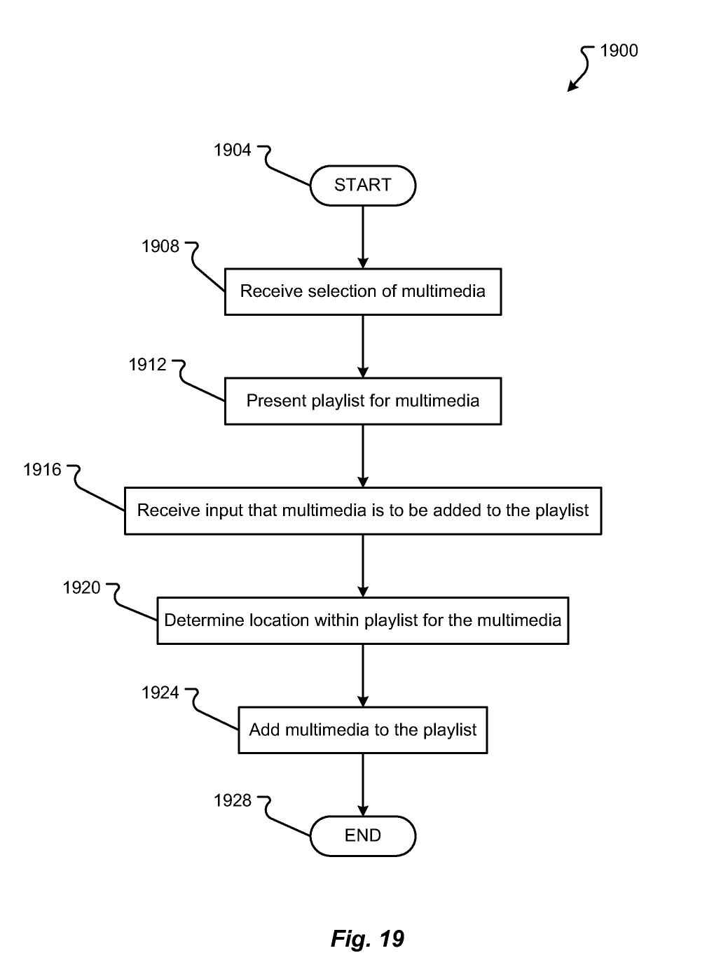

An embodiment of a method 1900 for quickly changing the content of a playlist is shown in FIG. 19. While a general order for the steps of the method 1900 is shown in FIG. 19. Generally, the method 1900 starts with a start operation 1904 and ends with an end operation 1928. The method 1900 can include more or fewer steps or can arrange the order of the steps differently than those shown in FIG. 19. The method 1900 can be executed as a set of computer-executable instructions executed by a computer system and encoded or stored on a computer readable medium. Hereinafter, the method 1900 shall be explained with reference to the systems, components, modules, software, data structures, user interfaces, etc. described in conjunction with FIGS. 1 through 18, but especially, FIG. 7 through 18 which contain user interfaces for the multimedia player and other embodiments described of herein.

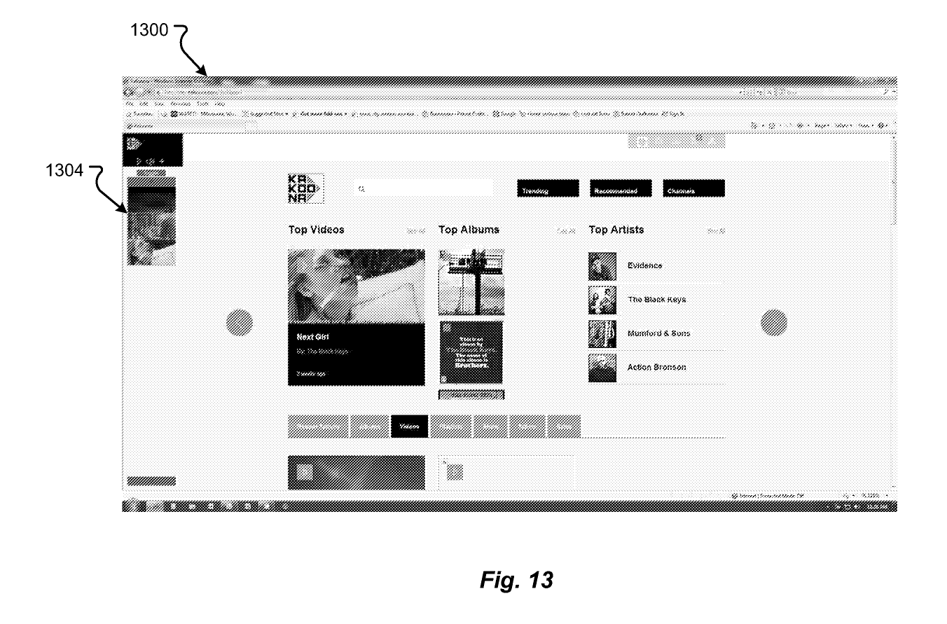

The user interaction module 316 or the intercept module 204 may present the information about the selected multimedia, such as the region in the user interface associated with the selection, to the user interface module 308 or the overlay user interface module 216. The user interface module 308 or the overlay user interface module 216 may present a playlist, such as playlist 1304 shown in window 1300 of FIG. 13, in step 1912. The playlist may include one or more selections of multimedia previously selected. The multimedia may be arranged in some logical order that shows a chronology of when or how the multimedia will be played in a media player. The playlist 1304 may be provided in any portion of the window 1300. As shown in FIG. 13, the playlist 1304 is a series of snapshots or thumbnail pictures of the multimedia arranged in an order along the side of the window 1300. In other examples, the playlist 1304 may be presented in a popup window or in a portion along the bottom of the window 1300. There may be other arrangements for the playlist which are contemplated and would be understood by one skilled in the art.

The user interaction module 316 or the intercept module 204 may interpret or receive input that the multimedia selected is to be added to the playlist 1304, in step 1916. In one example, the user may select a separate button or user selectable device that can be interpreted by the user interaction module 316 or intercept module 204 as a decision to add the multimedia to the playlist 1304. In other embodiments, the user may perform an action in the user interface, for example, a drag and drop operation that will be interpreted as a decision to add the multimedia to the playlist.

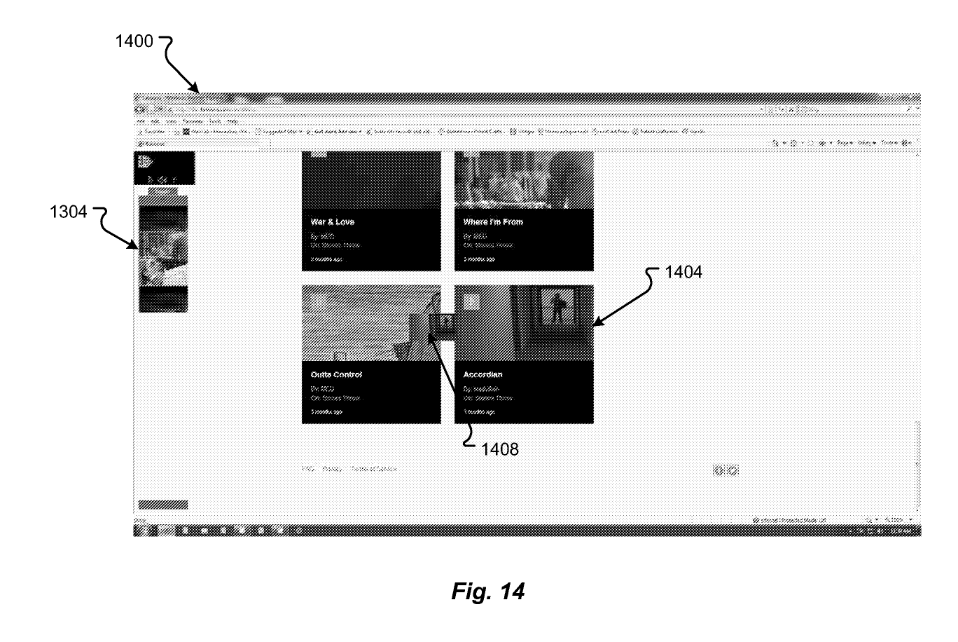

For example, as shown in FIG. 14, a new popup snapshot of multimedia 1404 is shown in section 1408. The thumbnail picture 1408 is presented in window 1400 as the user drag and drops that multimedia selection towards the playlist 1304. Thus, the window is moved and gives visual indicia to the user that the user is moving the selected multimedia 1404 towards the playlist 1304. The drag and drop motion will create or force the user interaction module 316 to send commands to user interface module 308 to present the snapshot 1408 during the drag and drop operation. Likewise, the user interaction module 316 interprets this action as desiring to add that multimedia to the playlist. These steps can also be performed by the intercept module 204 and/or the overlay user interface module 216.

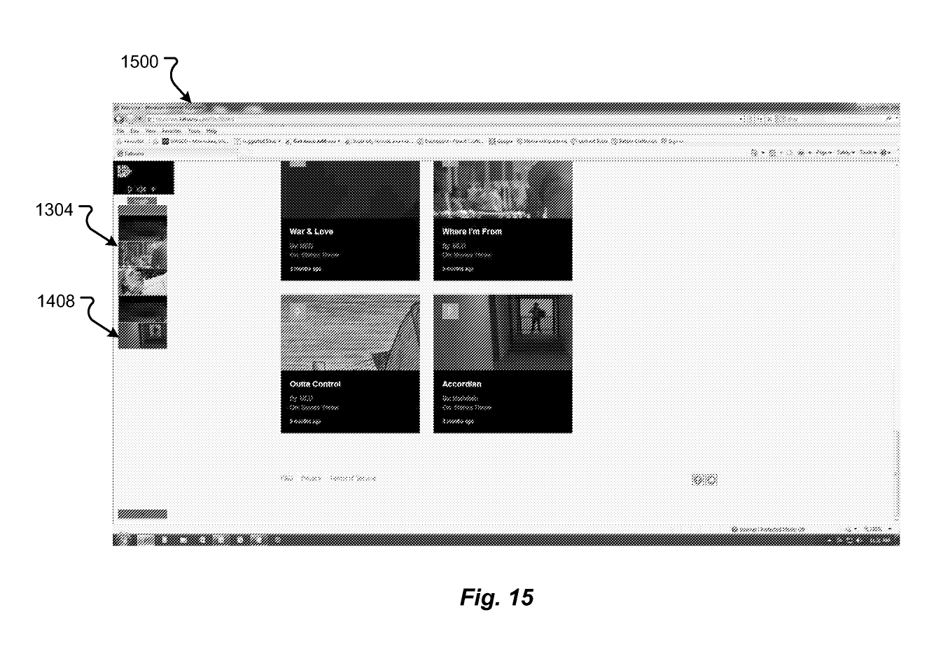

The user interaction may drop the snapshot 1408 in the playlist 1304. Based on the location of the drop action in the playlist 1304, the user interaction module 316 or the intercept module 204 can determine a location within the playlist or to place the multimedia, in step 1920. As explained previously, the playlist 1304 may be in a chronological order. The chronological order represents the order in which the multimedia will be played in a multimedia player. By dropping the selection 1408 into a position within the playlist, the user can change the order of the multimedia played in the multimedia player. Thus, selection 1408 can be placed at the beginning, somewhere in the middle, or at the end of the playlist 1304. In an example shown in FIG. 15, the user may drop the selection 1408 at the end of the playlist 1304 as shown in window 1500. If it is dropped at the end, the user interaction module 316 or the intercept module 204 can determine that the location within the playlist 1304 is at the end. It may also be possible to change the order of the existing multimedia in the playlist 1304 by dragging the thumbnails into different positions with the playlist 1304.

The user, after selecting or making this action, then adds the multimedia to the playlist. The user interaction module 316 or the intercept module 204 can add the multimedia to the play list, in step 1924, by changing the playlist data structure 602 shown in FIG. 6. Thus, the user interaction module 316 may send information to the database interface module 320 or the intercept module 204 may send information to a reroute module 212 to change a playlist 602. The playlist identifier 604 may be provided by determining the playlist 1304's location or other information that can either be used to look up the playlist identifier 604 or by providing the identifier as known by the user interaction module 316 or the intercept module 204. The multimedia can be identified or can provide information to identify the multimedia, such that an identifier 608 or 612 may be created by the database interface module 320 for the playlist. The order may also be determined and stored to place the multimedia identifier in the proper position within the playlist 602.

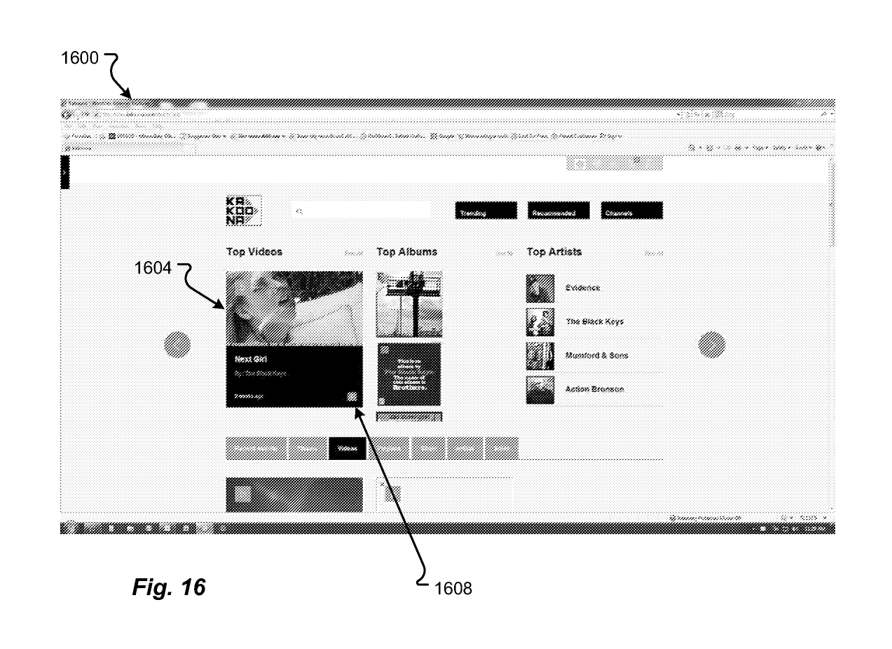

In other embodiments, the user may select an icon within a multimedia selection 1604. This user selectable icon 1608 as shown in window 16 of FIG. 16 can provide for placing the multimedia in a playlist. When selected, the multimedia may be placed at the end of the playlist regardless of how many selections of multimedia currently exist in the playlist. Thus, the user may have several options for placing multimedia within a playlist. When selected, the user interaction module 316 may perform actions as described herein to place the multimedia identifier within the data structure of the playlist 602 as described previously.

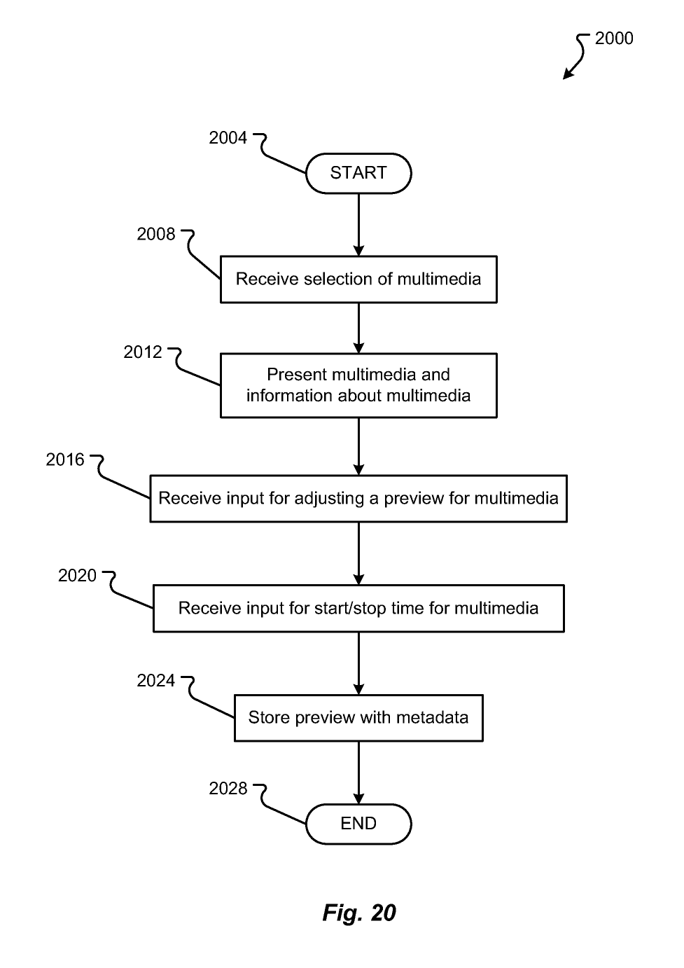

An embodiment of a method 2000 for creating a preview associated with the multimedia file is shown in FIG. 20. While a general order for the steps of the method 2000 is shown in FIG. 20. Generally, the method 2000 starts with a start operation 2004 and ends with an end operation 2028. The method 2000 can include more or fewer steps or can arrange the order of the steps differently than those shown in FIG. 20. The method 2000 can be executed as a set of computer-executable instructions executed by a computer system and encoded or stored on a computer readable medium. Hereinafter, the method 2000 shall be explained with reference to the systems, components, modules, software, data structures, user interfaces, etc. described in conjunction with FIGS. 1 through 19, but especially, FIG. 7 through 19 which contain user interfaces for the multimedia player and other embodiments described of herein.

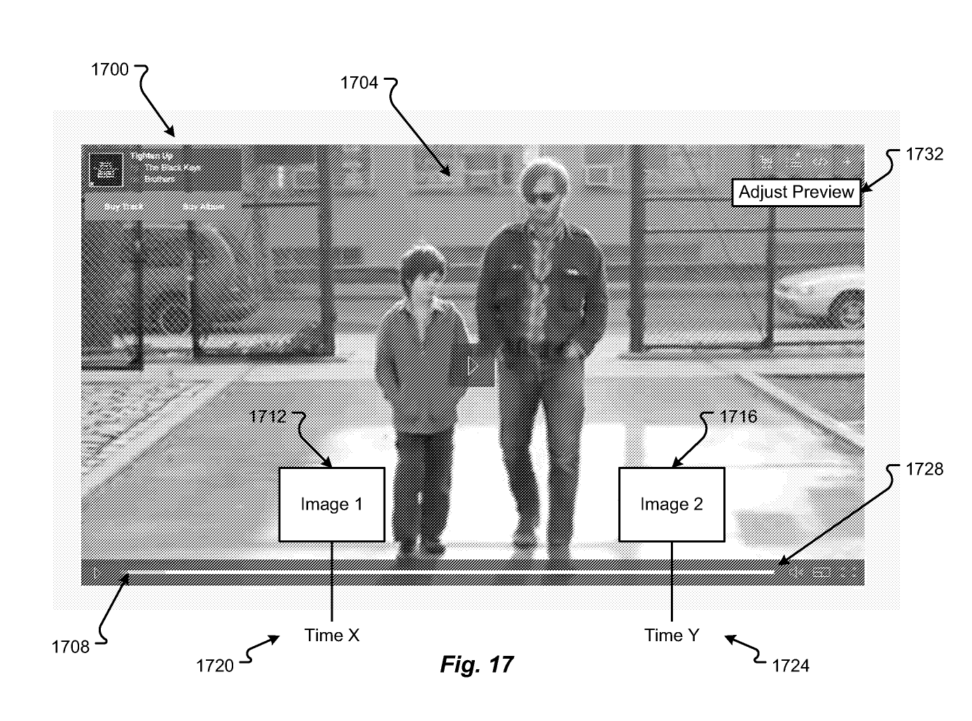

Providers of multimedia files may access features of the Kakoona server 104 that allows for changing information about the multimedia files. In the method 2000, the multimedia provider may interface with the user interaction module 316. The user interaction module 316 may receive a selection of a multimedia file, in step 2008. For example, the user may select multimedia that may then be presented in a multimedia player window 1704 as shown in window 1700 of FIG. 17. Thus, the user interaction module 316 can send information to the user interface module 308 to present the multimedia and present information about the multimedia, in step 2012. The current screen 1704 may be associated with a period of time within the multimedia, as represented by visual indicia 1708. The multimedia may play in a multimedia player and allow the user to view the multimedia within the multimedia player.

At some point thereinafter, the user interaction module 316 can receive input for adjusting a preview associated with the multimedia, in step 2016 (e.g., by selecting a user-selectable button 1732). A preview is a portion of the multimedia file that is used to entice other users to purchase the multimedia. This preview usually includes a viewable portion of the total multimedia file that may be bracketed or represented by a start time and a stop time within the multimedia file. With the Kakoona server 104, the user can adjust which preview is provided to the user rather than having a standard selection. For example, instead of providing the first minute of a four-minute multimedia file, the Kakoona server 104 can allow the user to adjust the start and stop times for the preview such that the user may view the third minute within the four-minute multimedia file or some other portion of the multimedia file. Thus, the user interaction module 316 can receive inputs for adjusting the preview for the multimedia file. For example, the user may select a bar or window 1712 that can be placed along the play bar 1728 as shown in window 1700. The placement of the window 1712 can set a start time 1720 for the preview. Likewise, the user interaction module 316 can receive an input for the placement of window 1716 within bar 1720 that represents a stop time 1724 that is desired to be set. Thus, by setting the start and stop times with the user-selectable windows 1712 and 1716 or controls within the play bar 1728 the user can establish a start and stop time 1720/1724 for the multimedia preview.

The user interaction module 316 can receive the input for the start and stop times for the multimedia, in step 2020. The information regarding when the preview is to start and stop may then be presented to the database interface module 320. The user interaction module 316 may provide the time 1720 and stop time 1724 as selected within the user interface window 1700. The timing information may then be used by the database interface module to store metadata 508 for the multimedia file 502 within the database 500. Thus, the database interface module 320 stores the information about the preview, in step 2024, within a multimedia database 112. The information is metadata 508 that then can be extracted by the Kakoona server 104 or a different user interface within the third party site 116 to provide the preview at a later time.

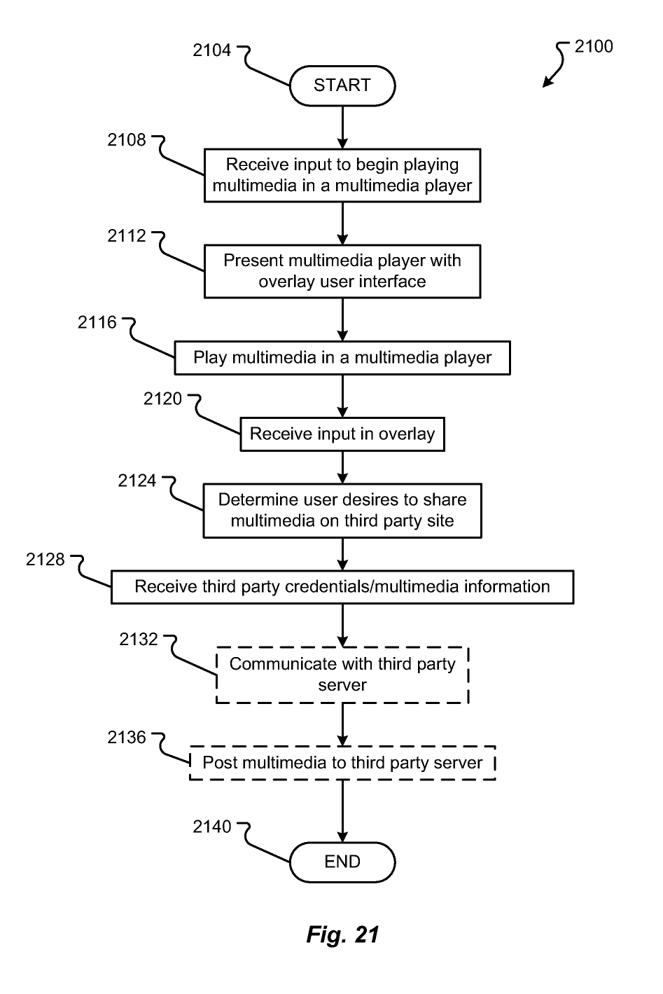

An embodiment of a method 2100 for inserting multimedia in a third party server is shown in FIG. 21. While a general order for the steps of the method 2100 is shown in FIG. 21. Generally, the method 2100 starts with a start operation 2104 and ends with an end operation 2140. The method 2100 can include more or fewer steps or can arrange the order of the steps differently than those shown in FIG. 21. The method 2100 can be executed as a set of computer-executable instructions executed by a computer system and encoded or stored on a computer readable medium. Hereinafter, the method 2100 shall be explained with reference to the systems, components, modules, software, data structures, user interfaces, etc. described in conjunction with FIGS. 1 through 20, but especially, FIG. 7 through 20 which contain user interfaces for the multimedia player and other embodiments described of herein.

The third party server 116, the Kakoona server 104, or the user computer 128 may receive input to begin playing a multimedia file 502 in a multimedia player, in step 2108. In embodiments, a third party server internet interface 120 may receive an input from a user computer 128 to play a multimedia selection from the multimedia database 140. In contrast, the user may also select a multimedia file 502 to play from a multimedia database 112 using the multimedia player module 304 of the Kakoona server 104. It is also possible that the user computer 128 may play a local multimedia file 502 from a user local database 132. The selection may be received by an intercept module 204 or a user interface module 308. The information may then be processed such that the local multimedia player may play the multimedia file 502 with an overlay user interface, in step 2112.

The third party server 116 may execute a multimedia player and use the Kakoona module 124 to play the multimedia file 502 from multimedia database 140 with an overlay user interface. Likewise, the Kakoona server 104 may execute a multimedia player module 304 and present an overlay user interface with the user interface module 308. An overlay user interface module 216 and the third party server 116 can generate the overlay and provide that overlay above an existing multimedia player or a multimedia player designed to work with the Kakoona module 124. The overlay may be as shown in FIG. 7.

The multimedia player 700 can include a series of different user interaction devices within or included with the overlay user interface. For example, Information about the embedded content of the multimedia file may be accessed through user selectable button 728. Further, user selectable button 732 may be used to embed the multimedia file in one or more third party sites. This overlay may be presented in the third party server 116, the user computer 128, and/or the Kakoona server 104. Thus, regardless of where the user may be viewing the multimedia, the Kakoona system may provide this overlay interface functionality to allow the user to both purchase and manage the multimedia file.

The multimedia player 304 or other multimedia player (not shown) herein may play the multimedia, in step 2116. Sometime thereinafter, a user interface may receive input in the overlay, in step 2120. For example, the intercept module 204 may receive an input in one of the sections of the overlay, as described herein. Likewise, the user interaction module 316 may receive an input in the overlay at the Kakoona server 104. Further, the user computer 128 may receive an input into an overlay. The input can be a selection of the user-selectable button or device 732.

Based on the input, the Kakoona module 124, Kakoona server 104, or user computer 128 may determine that the user desires to embed the multimedia content in a different third party website or server, in step 2124. The intercept module 204 can send the information about the selection to the identifier module 208, which can determine that the embed button 732 was selected. This information, and any information about the user, may be sent to the reroute module 212. The reroute module 212 can send the information to the Kakoona server 104. In other embodiments, the user computer 128 sends the information to the Kakoona server 104. In still other embodiments, the user interface module 316 receives the information for the Kakoona module 124. The third party interface module 312 can receive the information from the Kakoona module 124 or the user computer 128, in step 2128. Information about the user may then be retrieved by the database interface module 320 from user information file 402. The information can include credentials and other information needed to embed the content in another third party server or website.

The retrieved information may then be sent to the embed module 220 of the Kakoona module 124 or to the third party interface module 312. Either the embed module 220 of the Kakoona module 124 or to the third party interface module 312 may communication with the other third party server, in step 2132. The communication can include any information needed to logon or establish a connection with the social media account or website on the third party server. The embed module 220 of the Kakoona module 124 or to the third party interface module 312 may then post the multimedia chosen by the user onto the third party server, in step 2136. The posting may be done by an API or through a set of processes understood and retrieved by the embed module 220 of the Kakoona module 124 or to the third party interface module 312.

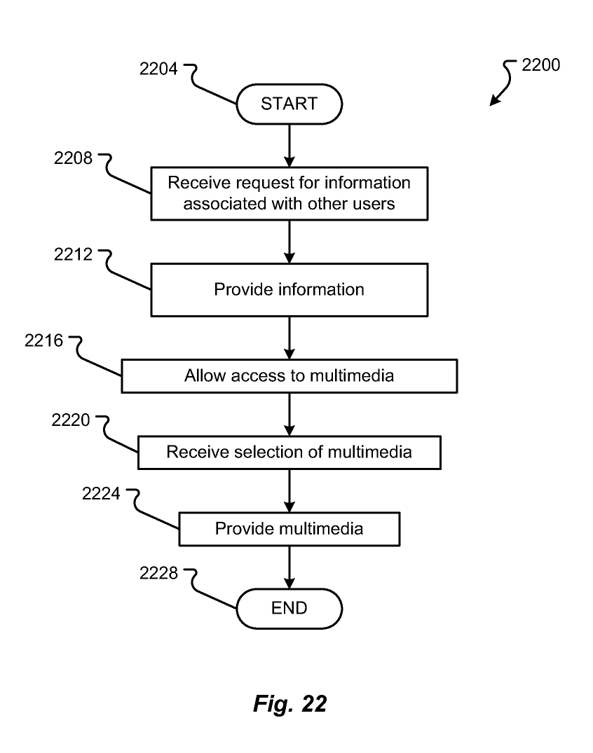

An embodiment of a method 2200 for locating multimedia based on social media connections is shown in FIG. 22. While a general order for the steps of the method 2200 is shown in FIG. 22. Generally, the method 2200 starts with a start operation 2204 and ends with an end operation 2240. The method 2200 can include more or fewer steps or can arrange the order of the steps differently than those shown in FIG. 22. The method 2200 can be executed as a set of computer-executable instructions executed by a computer system and encoded or stored on a computer readable medium. Hereinafter, the method 2200 shall be explained with reference to the systems, components, modules, software, data structures, user interfaces, etc. described in conjunction with FIGS. 1 through 21, but especially, FIG. 7 through 21 which contain user interfaces for the multimedia player and other embodiments described of herein.

The Kakoona server 104 can receive a request for information associated with other users, in step 2208. The request may provide information retrieved from a social media site, some other association between the user and a second party, or other information, in step 2212. The association allows the Kakoona server 104 to determine which second party the user desires access to or information from. The database interface module 320 may compare the provided information with credentials information 403 or other information stored in a user file 402. Any comparison may involve the determination that the user can access the second party's multimedia. If the user is deemed to have appropriate access to the second party multimedia, the user interaction module 316 may allow access to the second party's multimedia, in step 2216.

A user may then search the user file 402 for the second party. The database interface module 320 can provide information about the multimedia 408, 412, 416 associated with the second party. If the user desires one or more files of multimedia, the user interaction module 316 can receive a selection of the multimedia, in step 2220. Inputs into an overlay or other user interface are received by the user interaction module 316, which may pass the selection to the database interface module 320 to retrieve the multimedia file 502 and provide the multimedia file 502 to a multimedia player module 304. The multimedia player module 304 can then provide the multimedia file 502 to the user, in step 2224. In other embodiments, the user may purchase the multimedia file 502, which triggers the database interface module 320 to store a new pointer 516 to the multimedia file 502 in the user's file 402.

Computing Environment and Systems:

FIG. 23 illustrates a block diagram of a computing environment 2300 that may function as system or environment for the embodiments described herein. The system 2300 includes one or more user computers 2305, 2310, and 2315. The user computers 2305, 2310, and 2315 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 2305, 2310, and 2315 may also have any of a variety of applications, including for example, database client and/or server applications, and web browser applications. Alternatively, the user computers 2305, 2310, and 2315 may be any other electronic device, such as a thin-client computer, Internet-enabled mobile telephone, and/or personal digital assistant, capable of communicating via a network (e.g., the network 2320 described below) and/or displaying and navigating web pages or other types of electronic documents. Although the exemplary system 2300 is shown with three user computers, any number of user computers may be supported.

System 2300 further includes a network 2320. The network 2320 can be any type of network familiar to those skilled in the art that can support data communications using any of a variety of commercially-available protocols, including, without limitation, TCP/IP, SNA, IPX, AppleTalk, and the like. Merely by way of example, the network 2320 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system 2300 may also include one or more server computers 2325, 2330. One server may be a web server 2325, which may be used to process requests for web pages or other electronic documents from user computers 2305, 2310, and 2315. The web server can be running an operating system including any of those discussed above, as well as any commercially-available server operating systems. The web server 2325 can also run a variety of server applications, including HTTP servers, FTP servers, CGI servers, database servers, Java servers, and the like. In some instances, the web server 2325 may publish operations available operations as one or more web services.

The system 2300 may also include one or more file and or/application servers 2330, which can, in addition to an operating system, include one or more applications accessible by a client running on one or more of the user computers 2305, 2310, 2315. The server(s) 2330 may be one or more general purpose computers capable of executing programs or scripts in response to the user computers 2305, 2310 and 2315. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 2330 may also include database servers, including without limitation those commercially available from Oracle, Microsoft, Sybase™, IBM™ and the like, which can process requests from database clients running on a user computer 2305.

The web pages created by the web application server 2330 may be forwarded to a user computer 2305 via a web server 2325. Similarly, the web server 2325 may be able to receive web page requests, web services invocations, and/or input data from a user computer 2305 and can forward the web page requests and/or input data to the web application server 2330. In further embodiments, the server 2330 may function as a file server. Although for ease of description, FIG. 23 illustrates a separate web server 2325 and file/application server 2330, those skilled in the art will recognize that the functions described with respect to servers 2325, 2330 may be performed by a single server and/or a plurality of specialized servers, depending on implementation-specific needs and parameters. The computer systems 2305, 2310, and 2315, file server 2325 and/or application server 2330 may function as servers or other systems described herein.

The system 2300 may also include a database 2335. The database 2335 may reside in a variety of locations. By way of example, database 2335 may reside on a storage medium local to (and/or resident in) one or more of the computers 2305, 2310, 2315, 2325, 2330. Alternatively, it may be remote from any or all of the computers 2305, 2310, 2315, 2325, 2330, and in communication (e.g., via the network 2320) with one or more of these. In a particular set of embodiments, the database 2335 may reside in a storage-area network (“SAN”) familiar to those skilled in the art. Similarly, any necessary files for performing the functions attributed to the computers 2305, 2310, 2315, 2325, 2330 may be stored locally on the respective computer and/or remotely, as appropriate. In one set of embodiments, the database 2335 may be a relational database, such as Oracle 10i™, that is adapted to store, update, and retrieve data in response to SQL-formatted commands. Database 2335 may be the same or similar to the database used herein.

FIG. 24 illustrates one embodiment of a computer system 2400 upon which servers or other systems described herein may be deployed or executed. The computer system 2400 is shown comprising hardware elements that may be electrically coupled via a bus 2455. The hardware elements may include one or more central processing units (CPUs) 2405; one or more input devices 2410 (e.g., a mouse, a keyboard, etc.); and one or more output devices 2415 (e.g., a display device, a printer, etc.). The computer system 2400 may also include one or more storage device 2420. By way of example, storage device(s) 2420 may be disk drives, optical storage devices, solid-state storage device such as a random access memory (“RAM”) and/or a read-only memory (“ROM”), which can be programmable, flash-updateable and/or the like.

The computer system 2400 may additionally include a computer-readable storage media reader 2425; a communications system 2430 (e.g., a modem, a network card (wireless or wired), an infra-red communication device, etc.); and working memory 2440, which may include RAM and ROM devices as described above. In some embodiments, the computer system 2400 may also include a processing acceleration unit 2435, which can include a DSP, a special-purpose processor and/or the like.

The computer-readable storage media reader 2425 can further be connected to a computer-readable storage medium, together (and, optionally, in combination with storage device(s) 2420) comprehensively representing remote, local, fixed, and/or removable storage devices plus storage media for temporarily and/or more permanently containing computer-readable information. The communications system 2430 may permit data to be exchanged with the network 2420 and/or any other computer described above with respect to the system 2400. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 2400 may also comprise software elements, shown as being currently located within a working memory 2440, including an operating system 2445 and/or other code 2450, such as program code implementing the servers or devices described herein. It should be appreciated that alternate embodiments of a computer system 2400 may have numerous variations from that described above. For example, customized hardware might also be used and/or particular elements might be implemented in hardware, software (including portable software, such as applets), or both. Further, connection to other computing devices such as network input/output devices may be employed.

Payment Systems:

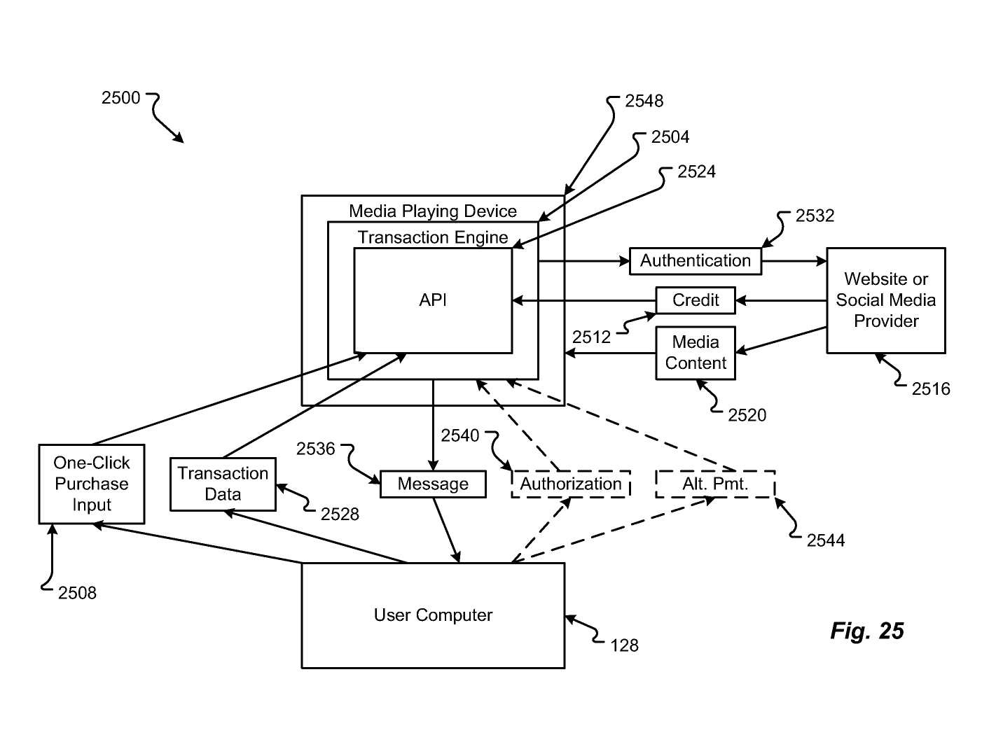

Applicants have also invented a novel media playing device that comprises a transaction engine, which allows a user to effectively use website credits or alternatively a credit card or similar authorized form of payment to instantly acquire media content viewed via the media playing device. The transaction engine can provide the user a one-click button for capture of payment information, authorization of payment, and download and delivery of the media content. The ability of the user to purchase media content via credits is based on a number of different criteria described in greater detail below. FIG. 25 shows the data communications 2500 undertaken by the transaction engine 2504. The engine 2504 may send and receive the communications 2500 up to and including the sending of the message 2536 automatically, after receiving a one-click purchase input 2508 from the user through an overlay user interface 2600 or other interface provided on the user computer 128.

If the user is paying with a credit 2512, such as a credit issued by a website provider or social media provider 2516, where the media content 2520 resides or has been viewed, the transaction proceeds to a remote machine hosted application programming interface (API) 2524. The purchase and transaction data 2528, transmitted from the user computer 128, can be transferred securely and encrypted before or in transport. Every byte of data that is received by or generated from the machine hosted API 2524 may be encrypted.

Once the transaction data has been received by the remote machine hosted API 2524, the engine 2504 determines the number of credits 2512 available to that user by communicating authentication data 2532 with the website or social media provider 2516.If the required value of credits is available to the user, the engine 2504 can authorize a message 2536 to be sent to the user. If the user has enough credits 2512, the user can be prompted for authorization 2540 to apply the specific amount of credits and process that transaction. If the user does not have sufficient credit 2512 available, then a message 2536 may be returned to the user informing the user of their credit status and permits the user to present an alternative form of payment 2544. Alternatively, the user may receive notification of insufficient credits in a message 2536 and the desired item may stay in their shopping cart until they purchase or acquire additional credits 2512.

Credits 2512 can be assigned by a website provider or social media provider 2516. The credits 2512 are, in embodiments, associated with a particular website(s) 2516 where the media content 2520 resides or is to be purchased. Part of the authentication process 2532 may be to determine whether the user indeed has credits 2512 with this website 2516 and in sufficient quantity to complete the desired transaction. The use of credits 2512 permits the transaction to occur seamlessly and easily in the first instance, by automatically approving the transaction without requesting the user to take even one more additional step, such as logging in and/or providing the user's financial and personal information. In this manner, the user may make a single click or tap via the media playing device 2552 and can apply those credits to purchase the media content 2520.

The API 2528 may rely on https (Hyper Tech Transfer Protocol Secure) and/or SSL (Secure Socket Layer) protocols to ensure the transaction(s) between the user and the engine 2504 described herein remain secure. In embodiments, the system employs Authorize.Net payment gateway services and First Data single-source payment processing for authorizing the transaction, and the media content 2520 can be downloaded instantly onto the media playing device 2548. One of ordinary skill in the art will recognize that other payment services and processes, including, without limitation, PayPal micropayments, may be used to authorize the transaction.

Advertising:

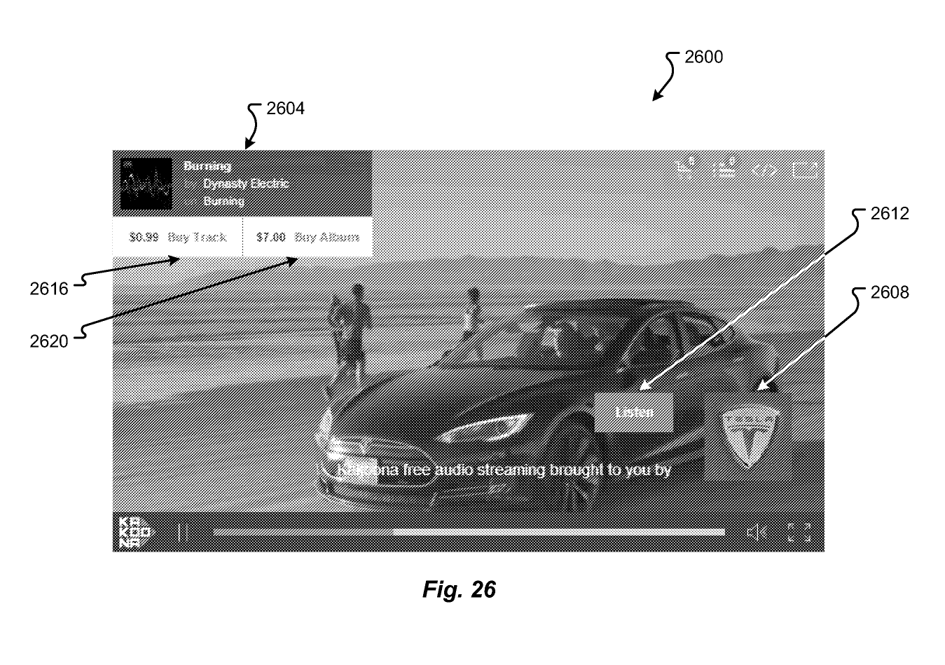

FIG. 26 shows an overlay user interface 2600 seen in conjunction with the use of a novel advertising device. The multimedia player module 304 or other multimedia players may stream or provide an audio track or audio media 2604 without accompanying video. In these situations, the overlay user interface 2600 may provide silent video advertisements 2608 while playing the audio media 2604. Thus, the user can view the advertisements 2608 while listening to their media 2604. The video 2608 may be provided as a separate file or multiplexed into a single multimedia steam that contains both the desired audio 2604 and the advertisements 2608. In other embodiments, the overlay user interface 2600 may provide video advertisements 2608 with accompanying audio that is muted by default. The user, while listening to audio media 2604 and viewing the video advertisement 2608, may desire to hear the audio accompanying the advertisement 2608 and can select a user selectable button 2612 in the overlay user interface 2600 to switch between the audio media 2604 and the audio accompanying the advertisement 2608 at any time.

In some embodiments, the overlay user interface may include at least one user selectable purchase button 2616, 2620 that the user can select to purchase the audio media 2604 when listening to the audio media 2604. When the user switches from the audio media 2604 to the audio accompanying the advertisement by selecting the user selectable button 2612, at least one user selectable purchase button 2616, 2620 can be associated with the product in the advertisement 2608 rather than the audio 2604. The user may then select at least one user selectable purchase button 2616, 2620 to buy the product in the advertisement 2608. Thus, with two clicks, the user may quickly and easily fulfill his or her desire to purchase the product shown in the video advertisement 2608.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a tablet-like device, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

A computer-readable medium embodying a database or data structure for storing multimedia content information can comprise, with respect to each of one or more multimedia files: a multimedia identifier that is unique to the multimedia file and identifies the multimedia file from the other multimedia files stored in the database; multimedia metadata, being any information specific to the multimedia file; and multimedia data, being the actual source data used to display or present the multimedia file to a user. The multimedia identifier can be a globally unique identifier. The multimedia metadata can include one or more of the artists associated with the multimedia file, the time the track was added to a multimedia database, the length of the multimedia file, and information about a preview associated with the multimedia file. The multimedia data can be read by the multimedia player module of a Kakoona server or by a multimedia player associated with a third party server. The multimedia data can be used by the multimedia player module of the Kakoona server or by the multimedia player associated with the third party server to present the multimedia file to the user.

A computer-readable medium embodying a database or data structure for storing playlist information, can comprise, with respect to each playlist: a playlist identifier that uniquely identifies the playlist for the user; and a multimedia pointer for each of one or more multimedia files associated with the playlist. The playlist identifier can include a globally unique identifier. The multimedia pointer may provide information to identify, retrieve, and arrange the multimedia in the playlist. The multimedia pointer can include the position of the multimedia within the playlist. The user may change the multimedia pointers by changing or adding to the playlist.

A method for providing a multimedia player in a third party server, may comprise: receiving input to begin playing multimedia in a multimedia player; presenting the multimedia player with an overlay user interface; playing the multimedia in the multimedia player; receiving input in the overlay user interface; determining the action required; performing the action; and communicating with a Kakoona server such that the Kakoona server may perform any further actions required. The input may be received by an intercept module of a Kakoona module or a user interface module of the Kakoona server, and the multimedia player may be a local multimedia player. The overlay user interface module of a Kakoona module and the third party server may generate the overlay user interface and may provide that overlay user interface above an existing multimedia player or a multimedia player designed to work with the Kakoona module. The overlay user interface may include one or more of a play bar, having one or both of a first visual indicia associated with the length of the multimedia file and a second visual indicia associated with the current position in the multimedia file; a volume adjust button; an expand-and-contract device selectable by a user to change the size of the window in which the multimedia player is presented; a display of one or more of the title, author or performer, album or collection title, release date, genre, and record label or publisher of the multimedia file; a purchase user selectable portion that allows the user to buy one or more of the multimedia file, an album, and a collection associated therewith, such that, in response to the user selecting the purchase user selectable portion, the multimedia file is added to an online shopping cart, and further includes a user selectable button by which the online shopping cart may be accessed; a playlist user selectable button that allows the user to see or access a playlist or multimedia play list; a content user selectable button that allows the user to access information about the embedded content of the multimedia file; and an embed user selectable button that allows the user to embed the multimedia file in one or more third party sites. When the user selects the purchase user selectable portion, the input may be received by the intercept module of a Kakoona module, which may provide information contained in the input to the identifier module of the Kakoona module to determine what action needs to be completed or what device was selected; the identifier module may interpret the information contained in the input to determine which multimedia file, album, or collection the user desires to buy, may collect information about the desired purchase, and may provide the information about the desired purchase to the reroute module of the Kakoona module that may send the information about the desired purchase to the Kakoona server; the Kakoona server may use its third party interface module to receive the information about the desired purchase from the reroute module of the Kakoona module, may store the information into an online shopping cart for the user and in a user database, and may provide information back to the reroute module of the Kakoona module to update the overlay user interface to show that there are items in the shopping cart; and the reroute module may provide the information to update the overlay user interface to show that there are items in the shopping cart to the overlay user interface module of the Kakoona module. When the user selects the purchase user selectable portion, the input may be received by the user interaction module of the Kakoona server, which may send information contained in the input to the database interface module of the Kakoona server to update a user database that one or more files are in the shopping cart and may update the overlay user interface to show that one or more items are in the shopping cart. The multimedia player may be presented as a webpage or other user interface that may be accessed through a website associated with the Kakoona server or through a user computer. When the user selects the purchase user selectable portion, a new popup window may be presented, displaying a selected multimedia file, album, or collection, and information about the file, album, or collection, to show that the user has selected the file, album, or collection for purchase, and having a first user selectable button that allows the user to check out as a guest and a second user selectable button that allows the user to check out by logging in through a Kakoona or Facebook account. When the user selects the content user selectable button, a popup window may be presented, providing information about the multimedia file and how the file may be embedded in a different third party server. When the user selects the embed user selectable button, a popup window may be presented, showing information about the multimedia file and having one or more user selectable devices which allow the user to do one or more of embed the multimedia file in a social media server, embed the multimedia file in a third party server, and email the multimedia file.

A method for quickly changing the content of a playlist may comprise receiving a selection of multimedia, presenting a playlist for the multimedia, receiving input of the user's movement of a pointer to a location corresponding with the multimedia, receiving input of the user's selection of the multimedia, receiving input from the user comprising dragging or moving the pointer across a user interface to a location corresponding to a position within the playlist while the multimedia is selected, receiving input of the user's deselection of the multimedia, determining the temporal position within the playlist at which the user desires to add the multimedia, and adding the multimedia to the playlist at the temporal position. The user interaction module of a Kakoona server or the intercept module of a Kakoona module may present information about the selected multimedia, such as the region in the user interface associated with the selection, to the user interface module of a Kakoona server or the overlay user interface module of a Kakoona module, and the user interface module of the Kakoona server or the overlay user interface module of the Kakoona module may present the playlist in a popup window or along the side or bottom of an existing window. The playlist may be presented as a series of snapshots or thumbnail pictures of the multimedia of which the playlist is comprised, arranged in some logical order that shows a chronology of when or how the multimedia will be played in a multimedia player. When the user selects the multimedia, a popup snapshot or thumbnail picture of the multimedia may be presented that moves with the user's pointer as the user drags the multimedia to provide visual indicia to the user that the user is moving the selected multimedia toward the playlist. The determination of the temporal position within the playlist at which the user desires to add the multimedia may be done by the user interaction module of a Kakoona server or the intercept module of a Kakoona module. The user may be able to change the order of the existing multimedia in the playlist by dragging the snapshots or thumbnail pictures into different positions within the playlist. The user interaction module of a Kakoona server may send information to the database interface module of the Kakoona server, or the intercept module of a Kakoona module may send information to the reroute module of the Kakoona module, to add the multimedia to the playlist by changing a playlist data structure. The user interaction module of the Kakoona server or the intercept module of the Kakoona module may be provided with a playlist identifier to uniquely identify the playlist to which the multimedia is to be added, or with information sufficient for the user interaction module of the Kakoona server or the intercept module of the Kakoona module to look up such a playlist identifier in a playlist database. The database interface module of the Kakoona server may modify the playlist identifier when the multimedia is added to the playlist. An icon may be provided with the multimedia selection such that the user may add the multimedia selection to the end of the playlist with a single click.

A method for creating a preview associated with a multimedia file may comprise receiving a selection of multimedia, presenting the multimedia and information about the multimedia, receiving input for adjusting a preview for the multimedia, receiving input for one or more of a start time and a stop time for the multimedia, and storing the preview with metadata. The selection of multimedia may be received by the user interaction module of a Kakoona server. The user interaction module of the Kakoona server may send information to the user interface module of the Kakoona server to present the multimedia and information about the multimedia in a multimedia player window. The multimedia player window may contain a visual indicia representing the current position within the multimedia as the multimedia plays. The multimedia player window may contain a user selectable button and the user interaction module of the Kakoona server may interpret the user's selection of the user selectable button as an input for adjusting the preview. The multimedia player window may contain a play bar and a user selectable bar or window that can be placed along the play bar by the user, the placement of such bar or window being received and interpreted by the user interaction module of the Kakoona server as an input for setting the start time for the preview. The multimedia player window may contain a play bar and a user selectable bar or window that can be placed along the play bar by the user, the placement of such bar or window being received and interpreted by the user interaction module of the Kakoona server as an input for setting the stop time for the preview. The user interaction module of the Kakoona server may present information regarding one or more of the start time and the stop time to the database interface module of the Kakoona server. The database interface module of the Kakoona server may use the information regarding one or more of the start time and the stop time to store metadata associated with the multimedia file and the preview within a multimedia database. The metadata may be able to be extracted by the Kakoona server or a different user interface within a third party site to provide the preview at a later time.

A method for inserting multimedia in a third party server may comprise a Kakoona module receiving input to begin playing multimedia in a multimedia player, the Kakoona module presenting the multimedia player with an overlay user interface, the Kakoona module playing the multimedia in the multimedia player, the Kakoona module receiving input in the overlay user interface, the Kakoona module determining that the user desires to share the multimedia on the third party site, a Kakoona server receiving third party credentials and multimedia information, the Kakoona server communicating with the third party server, and the Kakoona server posting the multimedia to the third party server. The overlay user interface may be provided above an existing multimedia player or a multimedia player designed to work with the Kakoona module. The overlay user interface may include a content user selectable button that allows the user to access information about the embedded content of the multimedia file. The overlay user interface may include an embed user selectable button that allows the user to embed the multimedia file in one or more third party sites. When the user selects the embed user selectable button, the intercept module of the Kakoona module may send information about the selection to the identifier module of the Kakoona module, which may determine that the embed user selectable button was selected. The identifier module of the Kakoona module may send the information about the selection and information about the user to the reroute module of the Kakoona module. The reroute module of the Kakoona module may send the information about the selection and the information about the user to the Kakoona server. The user interface module of the Kakoona server may receive the information about the selection and the information about the user from the reroute module of the Kakoona module. The third party interface module of the Kakoona server may retrieve the third party credentials and multimedia information. The database interface module of the Kakoona server may retrieve information about the user from a user information file, including credentials and other information needed to embed the content in another third party server or website.

A method for locating multimedia based on social media connections may comprise a Kakoona server receiving a request from the user for information associated with or access to other users, determining to which second party the user desires access or from which second party the user desires information, comparing information contained in the request to information stored in user files, and determining, on the basis of the comparison, whether the user may be allowed access to the multimedia associated with the second party. If the user is allowed access to the multimedia content associated with the second party, the user interaction module of the Kakoona server may allow the user access to the multimedia associated with the second party. The user interaction module of the Kakoona server may allow the user to search a user file associated with the second party. The database interface module of the Kakoona server may provide information about the multimedia associated with the second party. The user interface module of the Kakoona server may provide a user interface into which the user can make inputs indicating a desire for one or more files of multimedia associated with the second party. When the user makes inputs indicating a desire for one or more files of multimedia, the user interaction module of the Kakoona server may receive the inputs and a selection of the multimedia and may pass the selection to the database interface module. The database interface module of the Kakoona server may retrieve the one or more files of multimedia desired by the user and may provide them to the multimedia player module of the Kakoona server. The multimedia player module may provide the multimedia file to the user. The database interface module of the Kakoona server may retrieve the one or more files of multimedia desired by the user and the Kakoona server may provide a means for the user to purchase the one or more files of multimedia. When the user purchases the one or more files of multimedia, the database interface module of the Kakoona server may store a new pointer to each of the one or more files in a user file associated with the user.

A system functioning as a computing environment may comprise one or more user computers, one or more servers, a database, and a network interconnecting the one or more user computers, the one or more servers, and the database capable of supporting data communications using any of a variety of commercially-available protocols, such as TCP/IP, SNA, IPX, and AppleTalk. The system may be one of, or a group of any one or more of, a local area network, a wide-area network, a virtual network, the Internet, an intranet, an extranet, a public switched telephone network, an infra-red network, and a wireless network. One or more servers may be a web server used to process requests for web pages or other electronic documents from the one or more user computers. One or more servers may be an application server including one or more applications accessible by a client running on one or more of the user computers. The database may be a relational database that is adapted to store, update, and retrieve data in response to SQL-formatted commands.

A system upon which servers or other computer systems may be deployed or executed may comprise one or more central processing units, one or more input devices, one or more output devices, one or more storage devices, a computer-readable storage media reader, a communications system, and a working memory, within which may be located one or more software elements, such as an operating system or program code implementing servers or devices, and all of these elements may be electrically coupled via a bus. The system may further comprise a processing acceleration unit. The computer-readable storage media reader may be further connected to a computer-readable storage medium. The communications system may permit data to be exchanged with a network. The system may be connected to other computing devices, such as network input/output devices.

A computer-readable medium embodying a media playing device may comprise a transaction engine, in the form of a remote machine hosted application programming interface, that allows a user to use website credits or a credit card or similar authorized form of payment to instantly acquire media content viewed via the media playing device. If the user is paying with website credits, the transaction engine may utilize one or more of HTTPS protocols, SSL protocols, and other secure communication protocols to encrypt and transfer securely every byte of data, including purchase and transaction data, that is received or generated by the transaction engine. The transaction engine may determine the number of credits available to the user, and, if the user has enough credits to satisfy the transaction, may prompt the user for authorization to apply the specific quantity of credits and process the transaction, or, if the user does not have enough credits, may return a message informing the user of his or her status and permitting the user to present an alternative form of payment. If the website credits are assigned by a website where the media content to be purchased resides, the transaction engine may determine whether the user has credits with the website in sufficient quantity to complete the desired transaction, and may automatically approve the transaction without requesting the user to take any additional step if the user has sufficient credits with the website, such that the user can purchase the media content using the credits with a single click or tap. The transaction engine may use PayPal micropayments to authorize the transaction and the media playing device may download the content instantly.

A computer-readable medium embodying a multimedia player may comprise a means for advertising by which an audio track or audio media may be streamed without accompanying video. The computer-readable medium may further comprise an overlay user interface. The overlay user interface may provide silent video advertisements while the multimedia player plays audio media. The video advertisements may be provided as standalone files separate from files embodying the audio media. The video advertisements and the audio media may be multiplexed into a single multimedia stream.

A computing system may comprise a multimedia player module that plays or presents multimedia files for a user when visiting a website associated with a Kakoona server, a user interface module that provides the user interfaces for the multimedia player module or other functions of the Kakoona server, a third party interface module that communicates with a third party server, a user interaction module that receives and interprets user interactions within the user interfaces provided by the user interface module, a database interface module that interfaces with a user database and a multimedia database, and a multimedia creation and management module that receives new multimedia files and manages those multimedia files. The user interface module may create the website associated with or other interfaces to the Kakoona server. The third party interface module may be able to do one or more of embed multimedia files into the third party server, communicate, including translating and interpreting when necessary, messages to or from the third party server, and provide for other communications to and from the third party server. The user interaction module may be able to respond to any kind of user interaction within a user interface or sent to the Kakoona server from a user computer or the third party server. The user may be able to use the multimedia creation and management module to do one or more of create a video or audio file that may be provided to the Kakoona server and stored within the multimedia database and change or modify one or more of a multimedia file and the metadata associated therewith.

A computing system may comprise an intercept module that intercepts different user interface inputs from a third party server that may be associated with functionality provided by a Kakoona server, an identifier module that identifies multimedia playing with a multimedia player on the third party server, a reroute module that reroutes different inputs from the third party server to the Kakoona server or to a user computer, an overlay user interface module that provides a user interface that exists on top of or over a multimedia presentation, and an embed module that embeds multimedia files into third party servers. The identifier module may be able to access a multimedia database or metadata associated with multimedia files being presented on the third party server. The reroute module may be able to do one or more of reroute shopping cart requests from the third party server to the Kakoona server and reroute information from the third party server to a second third party server to embed content onto the second third party server. The overlay user interface module may provide information to the intercept module such that the intercept module can determine which inputs into the user interface are to be sent to the reroute module. The embed module may be able to do one or more of accept embedded information and place or encode the embedded information into the third party server or website and send or provide a file for embedding in a second or unrelated third party server.

A computing system for purchasing multimedia content may comprise a Kakoona server in communication with a user database and a multimedia database, one or more third party servers, each having an Internet interface, a Kakoona module, and a multimedia database, and one or more user computers, each in communication with a separate user local database, and the Kakoona server may be in communication with each of the one or more third party servers and each of the one or more user computers, and each of the one or more third party servers may be in communication with each of the one or more user computers. The user database may do one or more of storing, managing, and retrieving information associated with one or more users, and the multimedia database may do one or more of storing, managing, and retrieving information associated with multimedia. The third party server may be a social media site, such as Facebook or Twitter. The third party server may include a Kakoona module. The user computer may provide the capability to view multimedia for a user.

A computer-readable medium embodying a database or data structure for storing user information may comprise, with respect to each of one or more users, user credential data, being any type of user name, password, or other information used to identify the user, user biographic data, being any information or metadata about the user's preferences and history, and a multimedia pointer for each of one or more multimedia files associated with the user. The user credential data may comprise one or more of alphanumeric data and biometric data. The user biographic data may be able to be accessed by one or more other users to provide for a social interaction. The multimedia pointer may provide for access to multimedia within a multimedia database. The database interface module of a Kakoona server may be able to add a new multimedia pointer to the database when the user buys a new multimedia file to demonstrate that the user owns the multimedia file.

What is claimed is:

1. A computing system comprising:
a multimedia player module that plays or presents multimedia files for a user when visiting a website associated with a Kakoona server;
a user interface module that provides the user interfaces for the multimedia player module or other functions of the Kakoona server;
a third party interface module that communicates with a third party server;
a user interaction module that receives and interprets user interactions within the user interfaces provided by the user interface module;
a database interface module that interfaces with a user database and a multimedia database; and
a multimedia creation and management module that receives new multimedia files and manages those multimedia files.

2. The computing system of claim 1, wherein the user interface module creates the website associated with or other interfaces to the Kakoona server.

3. The computing system of claim 1, wherein the third party interface module can do one or more of:
embed multimedia files into the third party server;
communicate, including translating and interpreting when necessary, messages to or from the third party server; and
provide for other communications to and from the third party server.

4. The computing system of claim 1, wherein the user interaction module can respond to any kind of user interaction within a user interface or sent to the Kakoona server from a user computer or the third party server.

5. The computing system of claim 1, wherein the user may use the multimedia creation and management module to do one or more of:
create a video or audio file that may be provided to the Kakoona server and stored within the multimedia database; and
change or modify one or more of a multimedia file and the metadata associated therewith.

6. A computing system comprising:
an intercept module that intercepts different user interface inputs from a third party server that may be associated with functionality provided by a Kakoona server;
an identifier module that identifies multimedia playing with a multimedia player on the third party server;
a reroute module that reroutes different inputs from the third party server to the Kakoona server or to a user computer;
an overlay user interface module that provides a user interface that exists on top of or over a multimedia presentation; and
an embed module that embeds multimedia files into third party servers.

7. The computing system of claim 6, wherein the identifier module is able to access a multimedia database or metadata associated with multimedia files being presented on the third party server

8. The computing system of claim 6, wherein the reroute module can do one or more of:
reroute shopping cart requests from the third party server to the Kakoona server; and
reroute information from the third party server to a second third party server to embed content onto the second third party server.

9. The computing system of claim 6, wherein the overlay user interface module provides information to the intercept module such that the intercept module can determine which inputs into the user interface are to be sent to the reroute module.

10. The computing system of claim 6, wherein the embed module can do one or more of:
accept embedded information and place or encode the embedded information into the third party server or website; and
send or provide a file for embedding in a second or unrelated third party server.

11. A computing system for purchasing multimedia content, comprising:
a Kakoona server in communication with a user database and a multimedia database;
one or more third party servers, each having an Internet interface, a Kakoona module, and a multimedia database; and
one or more user computers, each in communication with a separate user local database;
wherein the Kakoona server is in communication with each of the one or more third party servers and each of the one or more user computers, and each of the one or more third party servers is in communication with each of the one or more user computers.

12. The computing system of claim 11, wherein the user database does one or more of storing, managing, and retrieving information associated with one or more users, and the multimedia database does one or more of storing, managing, and retrieving information associated with multimedia.

13. The computing system of claim 11, wherein the third party server is a social media site, such as Facebook or Twitter.

14. The computing system of claim 11, wherein the third party server includes a Kakoona module.

15. The computing system of claim 11, wherein the user computer provides the capability to view multimedia for a user.
